(19) United States
(12) Patent Application Publication
(10) Pub. No.: US 2024/0018275 A1
(43) Pub. Date: Jan. 18, 2024

(54) SUBSTITUTED SCLEROGLUCAN, MANUFACTURING METHOD THEREFOR AND USE THEREOF

(71) Applicants: CHINA PETROLEUM & CHEMICAL CORPORATION, Beijing (CN); SINOPEC PETROLEUM ENGINEERING TECHNOLOGY SERVICE CO., LTD., Beijing (CN); SINOPEC ZHONGYUAN PETROLEUM ENGINEERING CO., LTD, Puyang, Henan (CN); SINOPEC ZHONGYUAN PETROLEUM ENGINEERING CP., LTD, Puyang, Henan (CN)

(72) Inventors: Xiqiang SI, Puyang, Henan (CN); Zhonghua WANG, Puyang, Henan (CN)

(21) Appl. No.: 18/253,874

(22) PCT Filed: Mar. 26, 2021
(86) PCT No.: PCT/CN2021/083303

§ 371 Date: May 22, 2023

(30) Foreign Application Priority Data
Dec. 18, 2020 (CN) 202011503418.6

(51) Int. Cl. C08B 37/00; C08F 251/00; C09K 8/24

(52) U.S. Cl. CPC C08B 37/0024; C08F 251/00; C09K 8/24

(57) ABSTRACT

Substituted scleroglucans are produced and are used in the producing drilling fluid compositions. Each of the substituted scleroglucans and combination thereof have substituent A, substituent B and substituent C, and optionally each or in combination have substituent D and substituent E. Substituent A contains in its structure a unit —C(═O)—O—, substituent B contains a unit —C(═O)—NH—, substituent C contains a unit

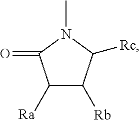

substituent D contains an aryl group, and substituent E contains a siloxane group. The substituted scleroglucan shows tackifying performance under high temperature conditions and a reduced filtration loss.

### TECHNICAL FIELD

The present invention relates to substituted scleroglucans, more particularly to a substituted scleroglucan or a mixture of a plurality of substituted scleroglucans. The invention also relates to a process of producing said substituted scleroglucan and to a drilling fluid composition produced from said substituted scleroglucan.

### BACKGROUND

With the increasingly strict environmental protection requirements of the world, a great deal of work is carried out in the world for green drilling fluid, wherein the key of the green drilling fluid is the greenization of drilling fluid treating agents and materials. Along with the implementation of new environmental protection laws of China since 2015, higher environmental protection requirements are put forward on the drilling fluid treating agent, the current drilling fluid treating agent is being developed towards greenization, and besides environmental protection factors, along with the increasing situations of drilling deep wells, ultra-deep wells and complex strata in the exploration and development process, the performance requirements to the drilling fluid treating agent on site are also higher and higher.

However, the drilling fluid treating agent in the prior art generally is suffered from the confliction between the environmental protection performance and the stability performance. Specifically, modified natural materials or biomass materials, such as starch, cellulose and xanthan gum, have good environmental protection performance, are nontoxic and are easy to biodegrade, but the temperature resistances are to be improved. The high molecular polymer treating agents, such as acrylamide and polyamine, have good stability, but are encountered with the problems of environmental protection, high toxicity and difficult biodegradation.

### SUMMARY OF INVENTION

The inventors of the invention discover that a product of substituted scleroglucan can be produced by gelatinization and grafting reaction on a plurality of hydroxyl active sites of scleroglucan molecules by utilizing the high-temperature viscosity stability and environment-friendly property of scleroglucan. The inventor of the invention also finds that the product has better high-temperature resistance and tackifying effect, is green and environment-friendly, and has important significance in environmental protection, reducing underground complexity, reducing drilling cost and the like. The present invention has been completed based on the discovery.

Specifically, the present invention relates to the following aspects.

1. A substituted scleroglucan or a mixture of a plurality of substituted scleroglucans, each or in combination having substituent A, substituent B and substituent C, and optionally each or in combination having substituent D and substituent E, wherein the substituent A comprises in its structure a unit-C(═O)—O— (preferably comprising a unit-C(═O)—O—R₁, wherein R₁ is selected from the group consisting of a hydrogen atom, an alkali metal (such as K or Na), an alkaline earth metal (such as Ca or Mg), ammonium (NH₄) and C1-10 or C1-4 linear or branched alkyl group), and the substituent B comprises in its structure a unit —C(═O)—NH— (preferably comprising a unit —C(═O)—NH—R₂, wherein R₂ is selected from the group consisting of a hydrogen atom and an optionally substituted C1-10 or C1-4 linear or branched alkyl group), the substituent C comprises in its structure a unit

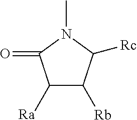

(wherein Ra, Rb and Rc, which are the same or different from each other, are each independently selected from a hydrogen atom and a C1-10 or C1-4 linear or branched alkyl group, preferably a hydrogen atom), the substituent D comprises in its structure an aryl group (preferably a phenyl group), and the substituent E comprises in its structure a siloxane group (preferably a siloxane group represented by —Si(OR′)₃, wherein R′ is a C1-4 linear or branched alkyl group, preferably a methyl or ethyl group).

2. The substituted scleroglucan or a mixture of a plurality of substituted scleroglucans of any preceding or subsequent aspect, wherein the substituent A is represented by formula (A-1), formula (A-2), or formula (A-3),

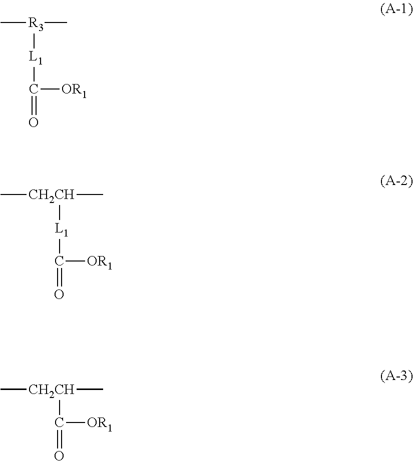

In the preceding formulae, the group R₃ is selected from C2-6 or C2-3 linear or branched alkylene (preferably ethylene or propylene), the group L₁ is selected from any linking group (preferably a single bond or C1-10 or C1-4 linear or branched alkylene, especially a single bond) preferably having no more than 10 carbon atoms, R₁ is selected from hydrogen, alkali metal (such as K or Na), alkaline earth metal (such as Ca or Mg), ammonium (NH₄) and C1-10 or C1-4 linear or branched alkyl),
The substituent B is represented by the following formula (B-1), formula (B-11), formula (B-12), formula (B-2), formula (B-21), formula (B-22), formula (B-3), formula (B-31) or formula (B-32),

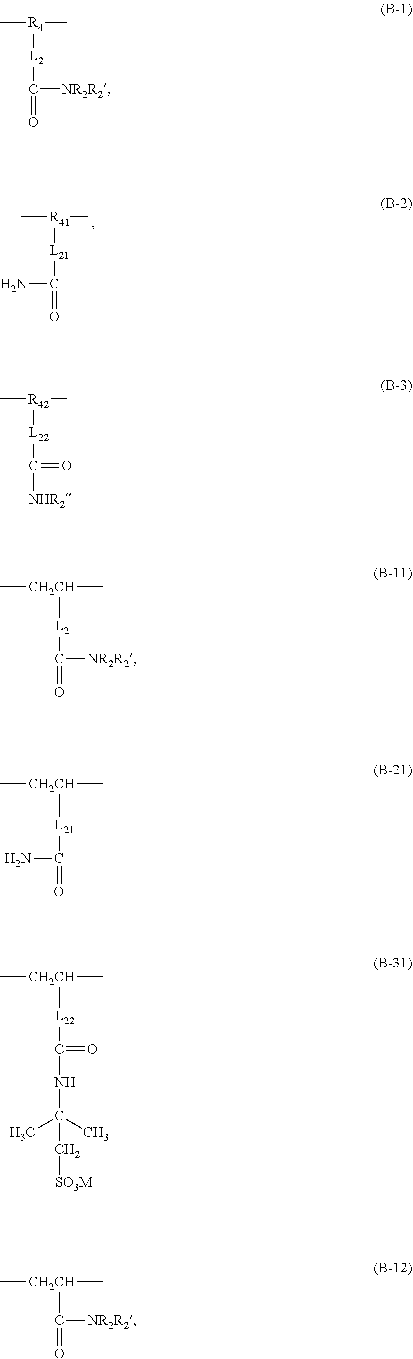

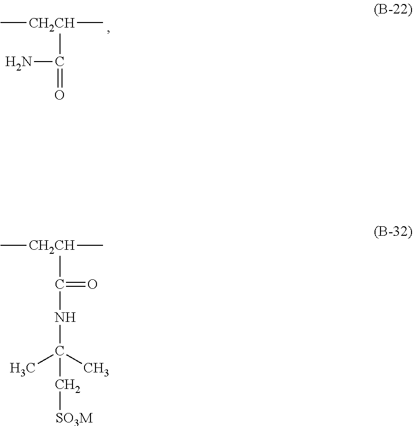

In the preceding formulae, the groups R₄, R₄₁, and R₄₂, same as or different from each other, are each independently selected from C2-6 or C2-3 linear or branched alkylene (preferably ethylene or propylene); the groups L₂, L₂₁, and L₂₂, same as or different from each other, are each independently selected from any linking group (preferably single bond or C1-10 or C1-4 linear or branched alkylene, especially single bond), preferably having no more than 10 carbon atoms; M is an alkali metal (such as K or Na), an alkaline earth metal (such as Ca or Mg) or ammonium (NH₄); R₂ is selected from a hydrogen atom and an optionally substituted C1-10 or C1-4 linear or branched alkyl, R₂′ is a hydrogen atom, R₂″ is selected from an optionally substituted C1-10 or C1-4 linear or branched alkyl,
The substituent C is represented by the following formula (C-1), formula (C-2) or formula (C-3),

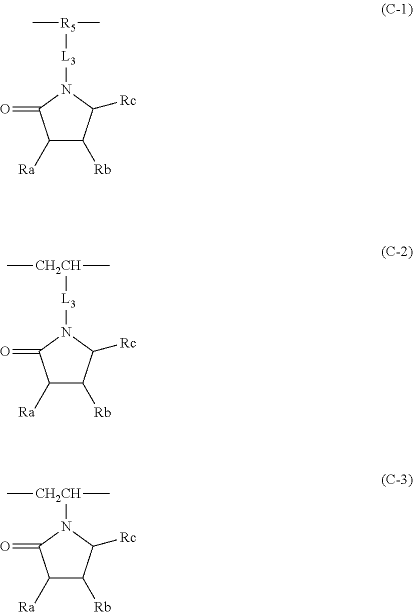

In the preceding formulae, the group R₅ is selected from C2-6 or C2-3 linear or branched alkylene (preferably ethylene or propylene); the group L₃ is selected from any linking group (preferably a single bond or C1-10 or C1-4 linear or branched alkylene, especially a single bond) preferably having no more than 10 carbon atoms; Ra, Rb and Rc, same as or different from each other, are each independently selected from a hydrogen atom and C1-10 or C1-4 linear or branched alkyl (preferably a hydrogen atom),
The substituent D is represented by the following formula (D-1) or formula (D-2),

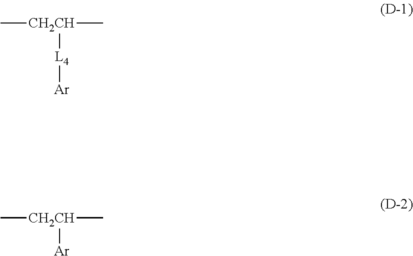

In the preceding formula, the group L₄ is selected from any linking group (preferably a single bond or a C1-10 or C1-4 linear or branched alkylene group, especially a single bond) preferably having no more than 10 carbon atoms, Ar is selected from a C6-20 aryl group (preferably phenyl),
The substituent E is represented by the following formula (E-1) or formula (E-2),

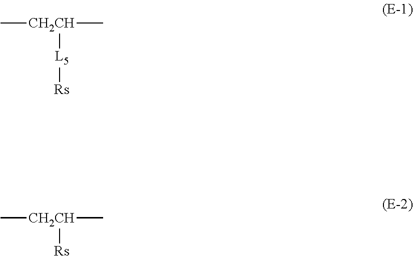

In the preceding formula, the group L₅ is selected from any linking group (preferably a single bond or a C1-10 or C1-4 linear or branched alkylene group, especially a single bond), preferably having no more than 10 carbon atoms; Rs is a siloxane group represented by —Si(OR′)₃ (wherein R′ is a C1-4 linear or branched alkyl group, preferably methyl or ethyl).

3. The substituted scleroglucan or a mixture of substituted scleroglucans of any preceding or subsequent aspect, which is a substituted scleroglucan represented by formula (I) or a mixture of a plurality thereof,

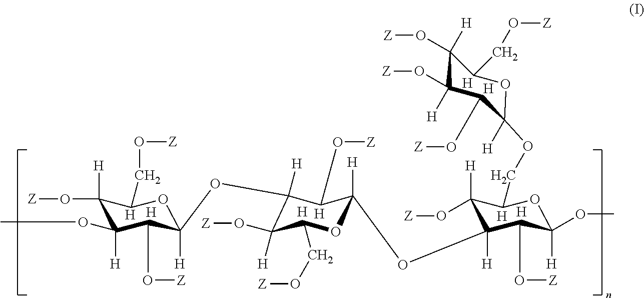

In the formula (I), n is 2000-20000, preferably 5000-10000, most preferably 6000-8000; each occurrence of Z, which are the same as or different from each other, independently represents a hydrogen atom, the substituent A, the substituent B, the substituent C, the substituent D, the substituent E, or a combination group of these substituents, provided that at least one occurrence of Z is not a hydrogen atom; and in each formula (I), assuming the average number of the substituent A is o′, the average number of the substituent B is x′, the average number of the substituent C is p′, the average number of the substituent D is y′, the average number of the substituent E is Z′, then o′ may be any number of from 1-40 (preferably 1-15), p′ may be any number of from 1-20 (preferably 1-10), x′ is any number from 1 to 40 (preferably from 1 to 20), y′ is any number from 0 to 20 (preferably from 1 to 15), and z′ is any number from 0 to 20 (preferably from 1 to 5).

4. The substituted scleroglucan or a mixture of substituted scleroglucans of any preceding or subsequent aspect, which is a substituted scleroglucan represented by the following formula (I-1) or a mixture of a plurality thereof,

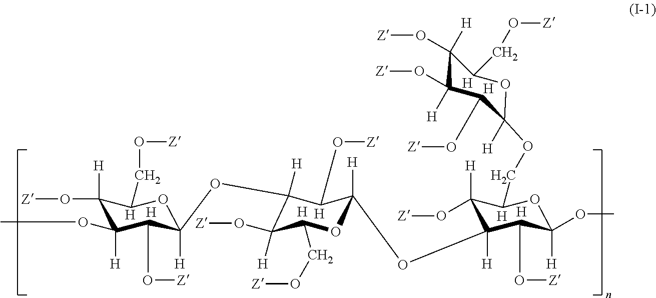

In the formula (I-1), n is 2000-20000, preferably 5000-10000, most preferably 6000-8000, each occurrence of Z′, which is the same as or different from each other, independently represents a hydrogen atom, a substituent A represented by formula (A-3) (called as substituent A′), a substituent B represented by formula (B-22) (called as substituent B′), a substituent B represented by formula (B-32) (called as substituent B″), a substituent C represented by formula (C-3) (called as substituent C′), a substituent D represented by formula (D-2) (called as substituent D′), a substituent E represented by formula (E-2) (called as substituent E′), or a combination group of these substituents, provided that at least one occurrence of Z′ is not a hydrogen atom, and in each formula (I-1), assuming that the average number of the substituents A′ is o, assuming that the average number of the substituents B′ is q, assuming that the average number of the substituents B″ is w, assuming that the average number of the substituents C′ is p, assuming that the average number of the substituents D′ is y, assuming that the average number of the substituents E′ is z, then o may be any number of from 1 to 20 (preferably 1 to 15), p may be any number of from 1 to 20 (preferably 1 to 10), q may be any number of from 1 to 20 (preferably 1 to 15), w may be any number of from 1 to 20 (preferably 1 to 10), y may be any number of from 0 to 20 (preferably 1 to 15), and z may be any number of from 0 to 20 (preferably 1 to 5).

5. The substituted scleroglucan or a mixture of substituted scleroglucans of any preceding or subsequent aspect, which is a substituted scleroglucan or mixture of more thereof represented schematically by the following formula (I-2),

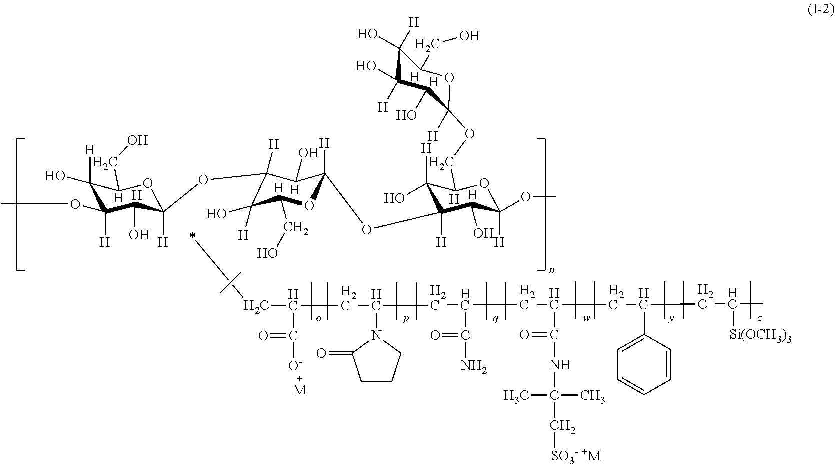

In formula (I-2), M is hydrogen, an alkali metal (such as K or Na), an alkaline earth metal (such as Ca or Mg) or ammonium (NH₄), and * represents a covalent bonding site.

6. A substituted scleroglucan or a mixture of a plurality of substituted scleroglucans any preceding or subsequent aspect, having an amine number of 0.2 to 0.6 mmol/g and/or an HLB value of 15.0 to 20.0.

7. A process of producing a substituted scleroglucan or a mixture of a plurality of substituted scleroglucans, comprising the steps of:
1) gelatinizing a scleroglucan represented by the following formula (A) in the presence of a alkali (or called as base) (preferably at least one selected from alkali metal hydroxides and alkaline earth metal hydroxides, particularly at least one selected from sodium hydroxide, potassium hydroxide and calcium hydroxide) and water to obtain a scleroglucan gel,

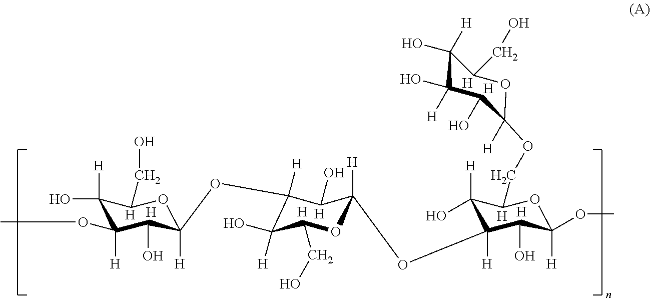

in the formula (A), n is 2000-20000, preferably 5000-10000, and most preferably 6000-8000,
2) mixing (preferably homogeneously mixing) a carboxylic acid monomer represented by formula (X-1), an amide monomer represented by formula (X-2), a sulfonic acid monomer represented by formula (X-3), a pyrrolidone monomer represented by formula (X-4), optionally a phenyl monomer represented by formula (X-5), and optionally a siloxane-based monomer represented by formula (X-6) with water in the presence of a base (preferably at least one selected from the group consisting of alkali metal hydroxides and alkaline earth metal hydroxides, particularly at least one selected from the group consisting of sodium hydroxide, potassium hydroxide and calcium hydroxide) to obtain a mixed monomer, and
3) subjecting the scleroglucan gel and the mixed monomers to a free-radical polymerization reaction in the presence of a free-radical polymerization initiator (preferably at least one selected from peroxide initiators, azo-based initiators, and redox-based initiators, in particular at least one selected from hydrogen peroxide, ammonium persulfate, azobisisobutyronitrile, ceric ammonium nitrate, and 1:2 parts by weight of sodium bisulfite and ammonium persulfate), optionally drying, to obtain the substituted scleroglucan or a mixture of a plurality of substituted scleroglucans,

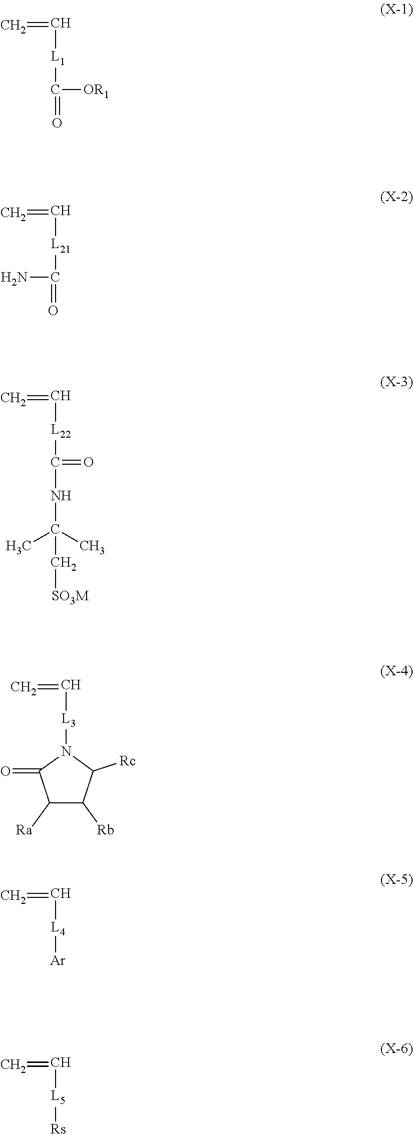

in the formulae (X-1) to (X-6), the groups L₁, L₂₁, L₂₂, L₃, L₄ and L₅, same as or different from each other, are each independently selected from any linking group (preferably a single bond or C1-10 or C1-4 linear or branched alkylene, particularly a single bond) preferably having a carbon number of no more than 10, M is an alkali metal (such as K or Na), an alkaline earth metal (such as Ca or Mg) or ammonium (NH₄), Ra, Rb and Rc, same as or different from each other, are each independently selected from hydrogen and C1-10 or C1-4 linear or branched alkyl (preferably hydrogen), R₁ is selected from hydrogen, an alkali metal (such as K or Na), an alkaline earth metal (such as Ca or Mg), ammonium (NH₄) and C1-10 or C1-4 linear or branched alkyl (preferably hydrogen), Ar is a C6-20 aryl group (preferably phenyl) and Rs is a siloxane group represented by —Si(OR′)₃ (wherein R′ is a C1-4 linear or branched alkyl group, preferably methyl or ethyl).

8. The production process of any preceding or subsequent aspect, wherein in the step 1), the weight ratio of the scleroglucan, water and the base is 12:(180-220):(4-8), and/or, in the step 1), the reaction is carried out at a temperature of 60-70° C., for 0.5-2 h, and/or, in the step 2), the weight ratio of the carboxylic acid monomer represented by formula (X-1), the pyrrolidone monomer represented by formula (X-4), the amide monomer represented by formula (X-2), the sulfonic acid monomer represented by formula (X-3), the base and water is 20:(15-18):(54-64):(27-36):(6-8):(50-80), and/or, in the step 2), the weight ratio of the carboxylic acid monomer represented by formula (X-1), the phenyl monomer represented by formula (X-5), and the siloxane-based monomer represented by formula (X-6) is 20:(27-45):(9-15), and/or, in the step 2), the mixing temperature is 30-40° C., and/or, in the step 3), the weight ratio of the mixed monomer (calculated as the total weight of all the monomers), the scleroglucan gel (calculated as the weight of the scleroglucan) and the free radical polymerization initiator is (152-198):12:(0.8-1.6), and/or, in the step 3), the pH value of the polymerization reaction system is controlled to be 8-10, the reaction temperature is 40-70° C., the reaction duration is 4-10 h, and/or, in the step 3), the drying temperature is 80-100° C.

9. A drilling fluid composition, comprising a substituted scleroglucan, a base slurry and optionally at least one treating agent, wherein the substituted scleroglucan is a substituted scleroglucan or a mixture of a plurality of substituted scleroglucans of any preceding or subsequent aspect, or a substituted scleroglucan or a mixture of a plurality of substituted scleroglucans produced by the process of any preceding or subsequent aspect.

10. A drilling fluid composition of any preceding or subsequent aspect, wherein the substituted scleroglucan is present in an amount of 0.5 to 10.0 wt % (preferably 1.5 to 5.0 wt %) by weight, based on 100 wt % of the total weight of the drilling fluid composition.

11. A process of producing a drilling fluid composition, comprising mixing a substituted scleroglucan, a base slurry and optionally at least one treating agent (preferably mixing the substituted scleroglucan with the base slurry first and then mixing the obtained mixture with the optionally at least one treating agent) to obtain the drilling fluid composition, wherein the substituted scleroglucan is a substituted scleroglucan or a mixture of a plurality of substituted scleroglucans of any preceding or subsequent aspect, or a substituted scleroglucan or a mixture of a plurality of substituted scleroglucans produced by the production process of any preceding or subsequent aspect, and optionally subjecting the obtained drilling fluid composition to an aging treatment (preferably at a treatment temperature of 120-200° C. or 140-180° C., preferably at a treatment temperature of 155-165° C. for 10-30 hours or 15-20 hours, preferably 15-17 hours).

Technical Effects

The substituted scleroglucan shows excellent tackifying performance under high temperature conditions, has excellent filtration loss reducing performance, is green and environment-friendly, and is particularly suitable for drilling fluid for deep well and ultra-deep well drilling construction with higher formation temperature.

The production process of the substituted scleroglucan has the advantages of mild reaction conditions, simple process operation, no waste water, waste gas and waste residue discharge, and environmental protection.

### DESCRIPTION OF DRAWINGS

FIG. 1 is an infrared spectrum of scleroglucan used in inventive examples and comparative examples.

FIG. 2 is an infrared spectrum of the substituted scleroglucan obtained in example 1.

### EMBODIMENTS

The embodiments of the present invention will be illustrated in more detail below, but it should be understood that the scope of the invention is not limited by the embodiments, but is defined by the claims appended.

All publications, patent applications, patents, and other references mentioned in this specification are herein incorporated by reference in their entirety. Unless defined otherwise, all technical and scientific terms used herein are understood same as the meanings commonly known to those skilled in the art. In case of conflict, definitions according to the present specification will control.

When the specification introduces materials, substances, processes, steps, devices, components, or the like initiated with “known to those ordinary skill in the art”, “prior art”, or the like, it is intended that the subject matter so initiated encompass not only those conventionally used in the art at the time of filing this application, but also those may not be so commonly used at the present time, but will become known in the art as being suitable for a similar purpose.

In the context of the present specification, aryl means, unless otherwise specified, C6-20 aryl, preferably phenyl.

In the context of the present specification, the expression “optionally substituted” means optionally substituted by one or more (such as 1 to 5, 1 to 4, 1 to 3, 1 to 2, or 1) substituents selected from the group consisting of hydroxy, C1-4 alkoxy, amino and sulfo (—SO₃M), preferably sulfo (—SO₃M). Here, M is an alkali metal (such as K or Na), an alkaline earth metal (such as Ca or Mg), or ammonium (NH₄).

In the context of the present specification, measurement of HLB value includes: weighing 1.0 g (accurate to 0.0001 g) of a sample to be tested, putting the sample to be tested into a clean and dry 250 mL conical flask, accurately weighing 99.0 g of deionized water, and putting the deionized water into the conical flask to produce 1.0% of aqueous solution of the sample to be tested. Gradually heating the conical flask in a constant-temperature water bath, wherein when the aqueous solution of the sample to be tested is reduced in transparency and becomes turbid, the temperature in the conical flask represents the cloud point T of the sample to be tested. Cloud point measurements were performed by randomly taking 3 batches of the sample to be tested. The HLB value was calculated according to formula (1):

HLB value=0.0980T+4.02 (1)
In the formula:
T: cloud point of sample to be tested in degrees Celsius (° C.).

In the context of the present description, the measurement of amine value comprises: 0.5 g of the sample to be tested (with accuracy to 0.0001 g) is weighed into a clean and dry 250 mL conical flask, 50 mL of deionized water is added and the total weight mi is recorded. 5 drops of bromocresol green-methyl red indicator are added into the solution to be detected, shaken homogeneously, and titration is made at a constant speed using a standard solution of hydrochloric acid dropwise. The color change of the solution is observed carefully while shaking homogeneously. When the color of the solution is changed from green to dark red, it is determined to be the titration end point. The volume V of the hydrochloric acid standard solution consumed is recorded. A blank test is carried out simultaneously. Amine value measurement is made for randomly sampled 3 batches of the test samples. The amine value is calculated according to formula (2):

$$Amine value = \frac{{C}_{HCl} \times ( V - {V}_{blank} )}{m} \qquad ( 2 )$$

in the formula:
Total amine value—calculated as H⁺, in the unit of millimoles per gram (mmol/g);
C_{HCl}—concentration of hydrochloric acid standard solution used, in moles per liter (mol/L);
V—value of the volume of the hydrochloric acid-isopropanol standard solution consumed by the sample to be detected, in milliliter (mL);
V_{Blank}—value of the blank hydrochloric acid solution, in milliliters (mL);
m—accurate value of the weight of the sample to be measured, in gram (g).

All percentages, parts, ratios, etc. involved in this description are provided by weight, while pressures are gauge pressures, unless explicitly indicated.

In the context of this description, any two or more embodiments of the invention may be combined in any manner, and the resulting solution is a part of the original disclosure of this description, and is within the scope of the invention.

According to an embodiment of the present invention, it relates to one/a substituted scleroglucan or a mixture of a plurality of substituted saccharides or glycosides. The term “one/a substituted scleroglucan” as used herein refers to a substituted scleroglucan present as a single compound, and the term “a mixture of a plurality of substituted saccharides or glycosides” refers to a mixture of two or more (i.e., a plurality of) substituted saccharides or glycosides. For the present invention, whether the substituted scleroglucan of the present invention is present in the form of respective compound independently or in the form of a mixture with each other, the intended purpose of the present invention can be achieved without any particular limitation. Thus, the present invention sometimes refers collectively to the one substituted scleroglucan and the plurality of substituted saccharides or glycosides collectively as substituted scleroglucan.

According to an embodiment of the present invention, the scleroglucan (or scleroglucan backbone) may be represented by the following formula (A). Here, the presence of scleroglucan can be determined by infrared analysis method. For example, the presence of said scleroglucan can be determined by showing characteristic peaks at or approaching to 3405, 2878, 1387, 1064 cm⁻¹ on the infrared spectrum of said substituted scleroglucan.

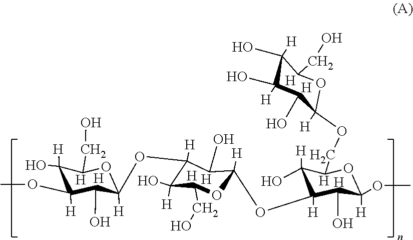

In the formula (A), n is 2000-20000, preferably 5000-10000, and most preferably 6000-8000.

According to an embodiment of the invention, the substituted scleroglucan each bears or in combination bears substituent a, substituent B and substituent C, each or in combination, and optionally bears substituent D and substituent E, i.e., the substituent D and the substituent E are optional substituents. Here, the term “bear” means that the substituent A, the substituent B, the substituent C, the substituent D (if any) and the substituent E (if any) are located on different scleroglucan molecules, respectively, and the term “in combination bear” means that the substituent A, the substituent B, the substituent C, the substituent D (if any) and the substituent E (if any) may be either located on different scleroglucan molecules, respectively, or may be located as a combination on different or the same scleroglucan molecule (e.g., two-by-two combination or three-by-three combination).

According to an embodiment of the invention, the substituent A comprises in its structure a unit —C(═O)—O—, preferably a unit —C(═O)—O—R₁, wherein R₁ is selected from the group consisting of hydrogen atom, alkali metal (such as K or Na), alkaline earth metal (such as Ca or Mg), ammonium (NH₄) and C1-10 or C1-4 linear or branched alkyl. Here, the presence of the units or the substituent A can be determined by an infrared analysis method. For example, the presence of these units or the substituent A can be determined by showing a characteristic peak at or approaching to 2938 cm⁻¹ on the infrared spectrum of the substituted scleroglucan.

According to an embodiment of the present invention, the substituent A may be represented by the following formula (A-1), formula (A-2), or formula (A-3).

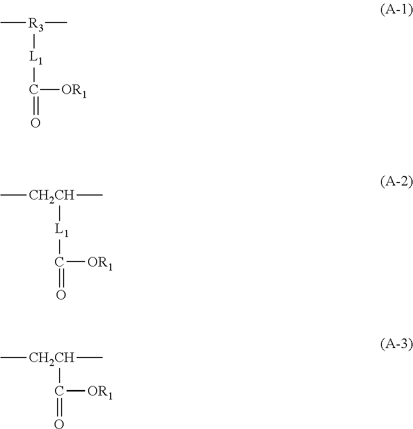

In the preceding formulae, the group R₃ is selected from C2-6 or C2-3 straight or branched chain alkylene, preferably ethylene or propylene. The group L₁ is selected from any linking group, preferably any linking group having no more than 10 carbon atoms, particularly preferably a single bond or a C1-10 or C1-4 linear or branched alkylene group, especially a single bond. R₁ is selected from the group consisting of hydrogen, alkali metal (such as K or Na), alkaline earth metal (such as Ca or Mg), ammonium (NH₄), and C1-10 or C1-4 straight or branched chain alkyl. In addition, all radical groups and values not explicitly defined here directly apply to the corresponding definitions given above in the description for the substituent A.

According to an embodiment of the invention, the substituent B comprises in its structure a unit —C(═O)—NH—, preferably a unit —C(═O)—NH—R₂, wherein R₂ is selected from the group consisting of a hydrogen atom and an optionally substituted C1-10 or C1-4 linear or branched alkyl group. Here, the presence of these units or the substituent B can be determined by an infrared analysis method. For example, the presence of these units or the substituent B can be determined by showing a characteristic peak at or approaching to 1195 cm⁻¹ on the IR spectrum of the substituted scleroglucan.

According to an embodiment of the present invention, the substituent B may be represented by the following formula (B-1), formula (B-11), formula (B-12), formula (B-2), formula (B-21), formula (B-22), formula (B-3), formula (B-31), or formula (B-32).

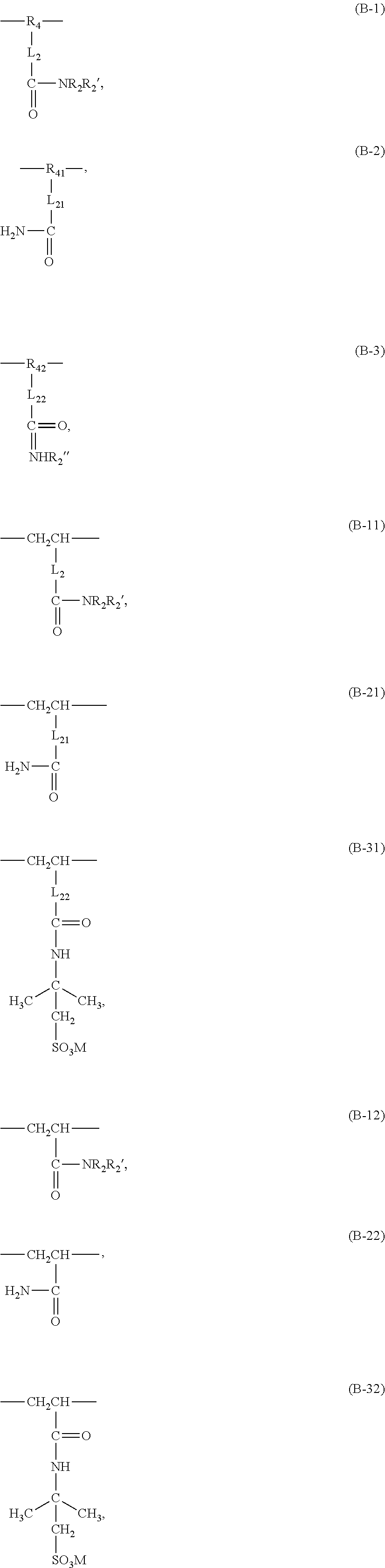

In the preceding formulae, the groups R₄, R₄₁, R₄₂, same as or different from each other, are each independently selected from C2-6 or C2-3 linear or branched alkylene, preferably ethylene or propylene. The groups L₂, L₂₁, and L₂₂, same or different from each other, are each independently selected from any linking group, preferably any linking group having no more than 10 carbon atoms, particularly preferably a single bond or a C1-10 or C1-4 linear or branched alkylene group, particularly a single bond. M is an alkali metal (such as K or Na), an alkaline earth metal (such as Ca or Mg) or ammonium (NH₄). R₂ is selected from the group consisting of a hydrogen atom and an optionally substituted C1-10 or C1-4 linear or branched alkyl group, R₂′ is a hydrogen atom, and R₂″ is selected from the group consisting of an optionally substituted C1-10 or C1-4 linear or branched alkyl group. In addition, all groups and values not explicitly defined here directly apply to the corresponding definitions given above in the description for the substituent B.

According to an embodiment of the invention, the substituent C comprises in its structure the unit

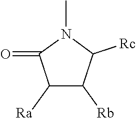

in which Ra, Rb and Rc, same as or different from each other, are each independently selected from a hydrogen atom and a C1-10 or C1-4 linear or branched alkyl group, preferably a hydrogen atom. Here, the presence of the unit or the substituent C may be confirmed by an infrared analysis method. For example, the presence of the unit or the substituent C can be determined by showing a characteristic peak at or approaching to 1674 cm⁻¹ on the infrared spectrum of the substituted scleroglucan.

According to an embodiment of the present invention, the substituent C may be represented by the following formula (C-1), formula (C-2), or formula (C-3).

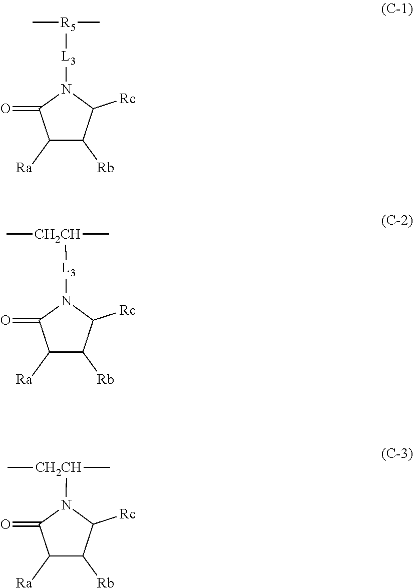

In the preceding formulae, the group R₅ is selected from C2-6 or C2-3 straight or branched chain alkylene, preferably ethylene or propylene. The group L₃ is selected from any linking group, preferably any linking group having no more than 10 carbon atoms, particularly preferably a single bond or a C1-10 or C1-4 linear or branched alkylene group, especially a single bond. Ra, Rb and Rc, same as or different from each other, are each independently selected from a hydrogen atom and a C1-10 or C1-4 linear or branched alkyl group, preferably a hydrogen atom. In addition, all groups and values not explicitly defined here directly apply to the corresponding definitions given in the description above for the substituent C.

According to an embodiment of the invention, the substituent D comprises in its structure an aryl group, preferably a phenyl group. Here, the presence of these units or the substituent D can be determined by an infrared analysis method. For example, the presence of these units or the substituent D can be determined by showing a characteristic peak at or approaching to 1453 cm⁻¹ on the IR spectrum of the substituted scleroglucan.

According to an embodiment of the present invention, the substituent D may be represented by the following formula (D-1) or formula (D-2).

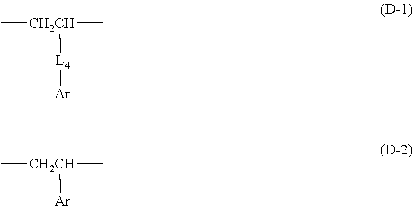

In the preceding formulae, the group L₄ is selected from any linking group, preferably any linking group having no more than 10 carbon atoms, particularly preferably a single bond or a C1-10 or C1-4 straight or branched chain alkylene group, especially a single bond. Ar is selected from C6-20 aryl, preferably phenyl. In addition, all groups and values not explicitly defined here directly apply to the corresponding definitions given hereinbefore for the substituent D.

According to an embodiment of the invention, the substituent E comprises in its structure a siloxane group, preferably a siloxane group represented by —Si(OR′)₃, wherein R′ is a C1-4 linear or branched alkyl group, preferably methyl or ethyl. Here, the presence of these units or the substituent E can be determined by an infrared analysis method. For example, the presence of these units or the substituent E can be determined by showing a characteristic peak at or approaching to 2150 cm⁻¹ on the IR spectrum of the substituted scleroglucan.

According to an embodiment of the present invention, the substituent E may be represented by the following formula (E-1) or formula (E-2).

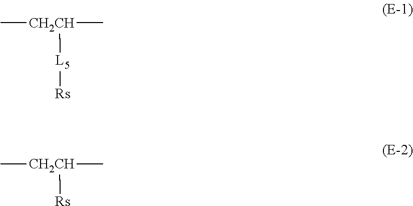

In the preceding formulae, the group L₅ is selected from any linking group, preferably any linking group having no more than 10 carbon atoms, particularly preferably a single bond or a C1-10 or C1-4 straight or branched chain alkylene group, especially a single bond. Rs is a siloxane group represented by —Si(OR′)₃, wherein R′ is a C1-4 linear or branched alkyl group, preferably methyl or ethyl. In addition, all groups and values not explicitly defined here directly apply to the corresponding definitions given hereinbefore for the substituent E.

According to an embodiment of the invention, the substituted scleroglucan is a substituted scleroglucan represented by formula (I) below or a mixture of a plurality thereof.

In the context of the present specification, the spatial configuration of any scleroglucan molecule or any substituted scleroglucan molecule is provided only for ease of understanding, but not intended to limit the invention. In fact, these molecules may be in any spatial configuration without departing from the spirit of the present invention.

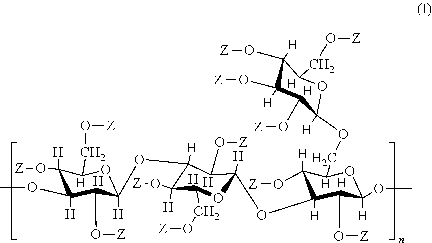

In the formula (I), n represents the degree of polymerization of a scleroglucan molecule, and is generally 2000-20000, preferably 5000-10000, and most preferably 6000-8000. Each occurrence of Z, same as or different from each other, independently represents a hydrogen atom, said substituent A, said substituent B, said substituent C, said substituent D, said substituent E, or a combination group of these substituents, provided that at least one occurrence of Z is not a hydrogen atom, i.e., at least one hydrogen atom on the —OH group of a scleroglucan molecule is replaced by one of these substituents. Here, the “combination group” refers to a chain structure formed by combining two or more same substituent or different substituents of the substituent A, the substituent B, the substituent C, the substituent D, and the substituent E in any bonding order, and specific illustrative examples are as follows, but the present invention is not limited thereto. In the present invention, the order of bonding between the same or different substituents is not particularly limited, and examples thereof include bonding between the same or different substituents in any order to form a chain structure such as random, block, or alternating.

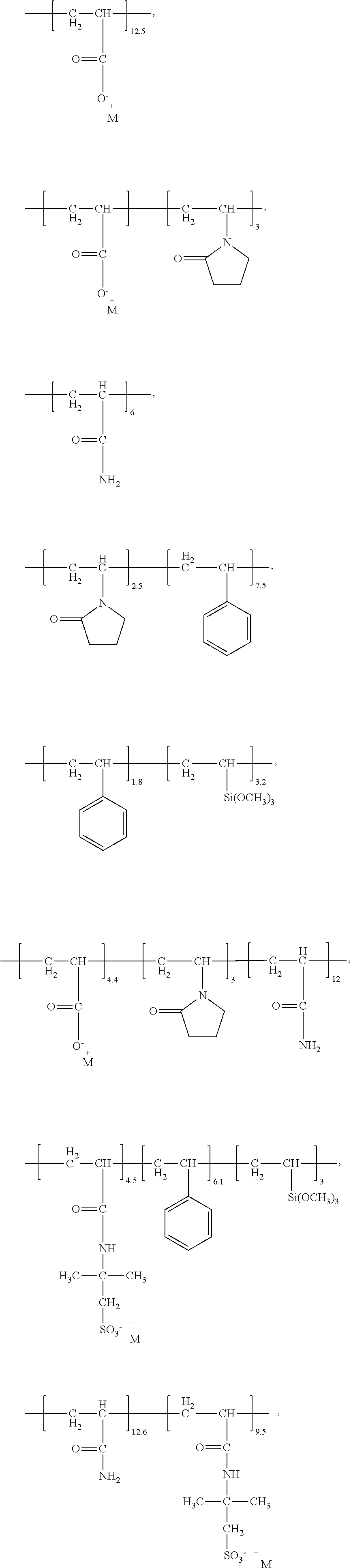

According to an embodiment of the present invention, in each formula (I), assuming the average number of the substituents a is o′, the average number of the substituents B is x′, the average number of the substituents C is p′, the average number of the substituents D is y′, and the average number of the substituents E is z′, then o′ may be any number of from 1 to 40 (preferably 1 to 15), p′ may be any number of from 1 to 20 (preferably 1 to 10), x′ may be any number of from 1 to 40 (preferably 1 to 20), y′ may be any number of from 0 to 20 (preferably 1 to 15), and z′ may be any number of from 0 to 20 (preferably 1 to 5). The present invention is not intended to limit or define the specific number of a substituent on a scleroglucan molecule, and so in the context of this specification, the term “average number” of a substituent refers to a statistically average number of the substituent relative to the total scleroglucan molecule. The number may be an integer or a non-integer.

According to an embodiment of the present invention, the substituted scleroglucan is a substituted scleroglucan represented by the following formula (I-1) or a mixture of a plurality thereof.

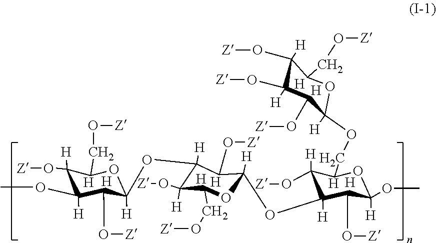

In the formula (I-1), n represents the degree of polymerization of a scleroglucan molecule, and is generally 2000-20000, preferably 5000-10000, and most preferably 6000-8000. Each occurrence of Z′, same or different from each other, independently represents a hydrogen atom, a substituent A represented by formula (A-3) (called as a substituent A′), a substituent B represented by formula (B-22) (called as a substituent B′), a substituent B represented by formula (B-32) (called as a substituent B″), a substituent C represented by formula (C-3) (called as substituent C′), a substituent D represented by formula (D-2) (called as substituent D′), a substituent E represented by formula (E-2) (called as substituent E′), or a combination group of these substituents, provided that at least one occurrence of Z′ is not a hydrogen atom, that is, the hydrogen atom on at least one —OH in a scleroglucan molecule is substituted by one of these substituents. Here, the “combination group” refers to a chain structure formed by combining two or more same substituent or different substituents of the substituent A′, the substituent B′, the substituent B″, the substituent C′, the substituent D′, the substituent E′ in any bonding order, and specific illustrative examples are as described above, but the present invention is not limited thereto. In the present invention, the order of bonding between the same or different substituents is not particularly limited, and examples thereof include bonding between the same or different substituents in any order to form a chain structure such as random, block, or alternating.

According to an embodiment of the present invention, in each formula (I-1), assuming that the average number of the substituents A′ is o, the average number of the substituents B′ is q, the average number of the substituents B″ is w, the average number of the substituents C′ is p, the average number of the substituents D′ is y, and the average number of the substituents E′ is z, then o may be any number of from 1 to 20 (preferably from 1 to 15), p may be any number of from 1 to 20 (preferably from 1 to 10), q may be any number of from 1 to 20 (preferably from 1 to 15), w may be any number of from 1 to 20 (preferably from 1 to 10), y may be any number of from 0 to 20 (preferably from 1 to 15), and z may be any number of from 0 to 20 (preferably from 1 to 5). As mentioned above, the present invention does not intend to limit or define the specific number of a substituent on a scleroglucan molecule, and therefore in the context of the present specification, by “average number” of a substituent is meant the statistically average number of said substituent relative to the total scleroglucan molecule. The number may be an integer or a non-integer. In addition, all groups and values not explicitly defined here directly apply to the corresponding definitions given above in this description for the formula (I).

According to an embodiment of the present invention, the substituted scleroglucan is a substituted scleroglucan represented schematically by the following formula (I-2) or a mixture of a plurality thereof. In the context of the present specification, by “schematic(ally)”, it is meant that the same and different substituents are all grouped together in one chain structure only for the sake of convenience of understanding, and in the chain structure, the same substituents form a block structure with the respective average number as the number of repeating units. However, this schematic representation does not imply that such chain structures must be present on the substituted scleroglucan molecules or mixtures thereof of the invention, that the same substituents must form separate blocks with the respective average number as the number of repeating units, nor that different substituents (including different blocks) must be bonded in the particular order shown in the formula. In fact, according to the spirit of the present invention, the same substituent or different substituents may be bonded to one or more scleroglucan molecules in any combination, such as replacing the hydrogen atom of one hydroxyl group on the scleroglucan molecule, either alone or in any combination. Examples of the combinations include bonding in any order to form a chain structure such as random, block, or alternating. These embodiments are intended to be included in the scope of the present invention and are not particularly limited. Other formulas in the specification can be similarly understood.

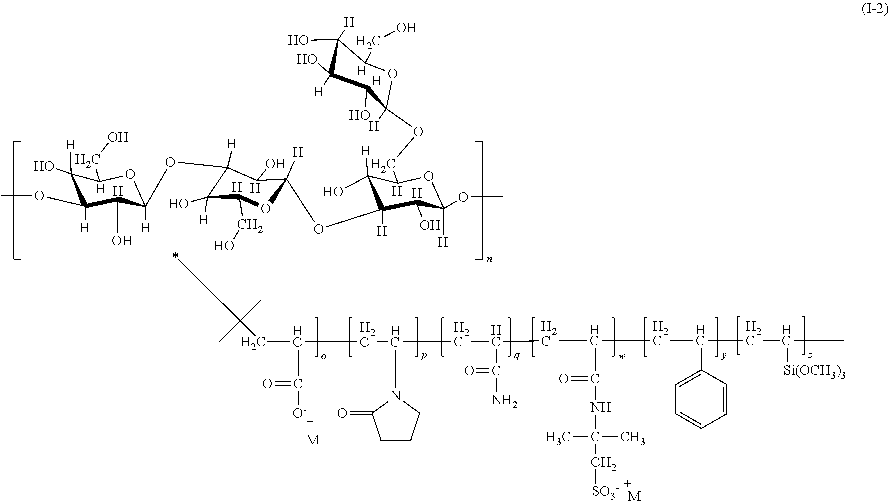

In the formula (I-2), M is hydrogen, an alkali metal (such as K or Na), an alkaline earth metal (such as Ca or Mg), or ammonium (NH₄). Furthermore, * represents a covalent bonding site, i.e., the chain structure will achieve covalent bonding to the scleroglucan molecule via the free end represented by said * (replacing a hydrogen atom of a certain hydroxyl group on the scleroglucan molecular structure). In addition, all the groups and values not explicitly defined herein directly apply to the corresponding definitions given herein before for said formula (I) or said formula (I-1).

According to an embodiment of the invention, the substituted scleroglucan has an amine number of 0.2 to 0.6 mmol/g.

According to an embodiment of the invention, the substituted scleroglucan has an HLB value of 15.0 to 20.0.

According to an embodiment of the invention, the substituted scleroglucan can be produced according to the process of producing a substituted scleroglucan or a mixture of a plurality of substituted scleroglucans of the invention.

According to an embodiment of the present invention, the production process may include the following steps.
1) gelatinizing a scleroglucan in the presence of alkali (base) and water to obtain a scleroglucan gel.

According to an embodiment of the present invention, in the step 1), the base is at least one selected from alkali metal hydroxide and alkaline earth metal hydroxide, in particular at least one of sodium hydroxide, potassium hydroxide and calcium hydroxide.

According to an embodiment of the invention, in said step 1), the weight ratio of said scleroglucan, water and said base is generally 12:(180-220):(4-8).

According to an embodiment of the invention, in said step 1), the reaction temperature is generally between 60 and 70° C. and the reaction duration is generally between 0.5 and 2 hours.

According to an embodiment of the present invention, in the step 1), the scleroglucan (i.e., one scleroglucan molecule) may be represented by the following formula (A).

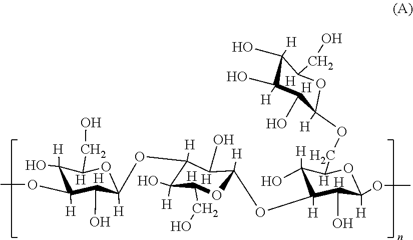

In the formula (A), n is 2000-20000, preferably 5000-10000, and most preferably 6000-8000.
2) mixing a carboxylic acid monomer represented by formula (X-1), an amide monomer represented by formula (X-2), a sulfonic acid monomer represented by formula (X-3), a pyrrolidone monomer represented by formula (X-4), optionally a phenyl monomer represented by formula (X-5), and optionally a siloxane-based monomer represented by formula (X-6) with water in the presence of a base, to obtain a mixed monomer. Here, for the mixing, homogeneous mixing is preferable

According to an embodiment of the present invention, in the step 2), the base is at least one selected from alkali metal hydroxide and alkaline earth metal hydroxide, in particular at least one selected from sodium hydroxide, potassium hydroxide and calcium hydroxide.

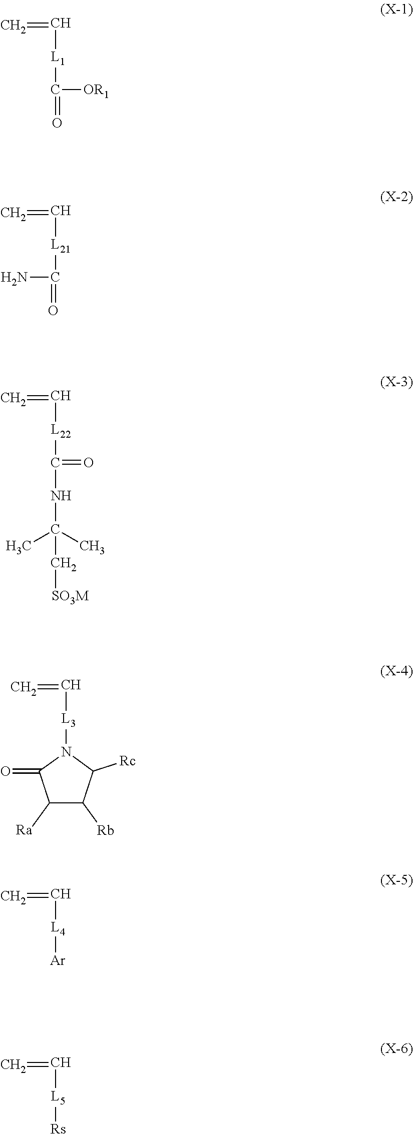

In the formulae (X-1) to (X-6), the groups L₁, L₂₁, L₂₂, L₃, L₄ and L₅, same as or different from each other, are each independently selected from any linking group, preferably any linking group having a carbon number of no more than 10, preferably a single bond, or a C1-10 or C1-4 linear or branched alkylene group, particularly a single bond. M is an alkali metal (such as K or Na), an alkaline earth metal (such as Ca or Mg) or ammonium (NH₄). Ra, Rb and Rc, same as or different from each other, are each independently selected from a hydrogen atom and a C1-10 or C1-4 linear or branched alkyl group, preferably a hydrogen atom. R₁ is selected from the group consisting of a hydrogen atom, an alkali metal (such as K or Na), an alkaline earth metal (such as Ca or Mg), ammonium (NH₄), and a C1-10 or C1-4 linear or branched alkyl group, preferably a hydrogen atom. Ar is a C6-20 aryl group, preferably phenyl. Rs is a siloxane group represented by —Si(OR′)₃, wherein R′ is a C1-4 linear or branched alkyl group, preferably methyl or ethyl.

According to an embodiment of the present invention, in the step 2), the weight ratio of the carboxylic acid monomer represented by formula (X-1), the pyrrolidone monomer represented by formula (X-4), the amide monomer represented by formula (X-2), the sulfonic acid monomer represented by formula (X-3), and the base to the water is 20:(15-18):(54-64):(27-36):(6-8):(50-80).

According to an embodiment of the present invention, in the step 2), the weight ratio of the carboxylic acid monomer represented by formula (X-1), the phenyl monomer represented by formula (X-5), and the siloxane-based monomer represented by formula (X-6) is 20:(27-45):(9-15).

According to an embodiment of the invention, in said step 2), the mixing temperature is generally between 30 and 40° C.
3) Subjecting the scleroglucan gel and the mixed monomer to a free radical polymerization reaction in the presence of a free radical polymerization initiator, optionally drying, to obtain the substituted scleroglucan. Here, drying is an optional step.

According to an embodiment of the present invention, in the step 3), the free radical polymerization initiator is selected from at least one of a peroxide initiator, an azo-based initiator, and a redox-based initiator, and particularly selected from hydrogen peroxide, ammonium persulfate, azobisisobutyronitrile, cerium ammonium nitrate, and at least one of sodium bisulfite and ammonium persulfate at a weight ratio of 1:2.

According to an embodiment of the present invention, in the step 3), the weight ratio of the mixed monomer (calculated as the total weight of all monomers), the scleroglucan gel (calculated as the weight of scleroglucan) and the free radical polymerization initiator is generally (152-198):12:(0.8-1.6).

According to an embodiment of the present invention, in the step 3), the pH of the polymerization reaction system is generally controlled to be 8 to 10, for example, by adding an aqueous solution of sodium hydroxide.

According to an embodiment of the present invention, in the step 3), the reaction temperature of the polymerization reaction system is generally 40 to 70° C., and the reaction duration is generally 4 to 10 hours.

According to an embodiment of the invention, in said step 3), the drying temperature is generally 80 to 100° C. The drying may be carried out in an oven. After drying, pulverization may be performed.

According to an embodiment of the present invention, the steps 1) to 3) may be performed under stirring. For this purpose, the stirring speed of the stirring is generally 800-4000 r/min, preferably 1000-1100 r/min.

According to an embodiment of the present invention, there is also provided a drilling fluid composition comprising a substituted scleroglucan, a base slurry and optionally at least one treating agent. The substituted scleroglucan may be any substituted scleroglucan or a mixture of substituted scleroglucans of the invention as described herein before or a substituted scleroglucan or a mixture of substituted scleroglucans produced by any of the producing processes of the invention as described herein before.

According to an embodiment of the invention, the substituted scleroglucan is typically present in the drilling fluid composition in an amount of initiators 0.5 to 10.0 wt %, preferably 1.5 to 5.0 wt %, based on 100 wt % of the total weight of the drilling fluid composition.

According to an embodiment of the invention, the invention also relates to a process for producing the drilling fluid composition. The producing process comprises a step of mixing a substituted scleroglucan, a base slurry and optionally at least one treating agent to obtain the drilling fluid composition (called as mixing step). The substituted scleroglucan here may be any substituted scleroglucan or a mixture of substituted scleroglucans of the invention as described herein before or a substituted scleroglucan or mixture of substituted scleroglucans produced by any of the processes of production of the invention as described herein before.

According to an embodiment of the present invention, as the at least one treating agent, any treating agent conventionally used in the art for drilling fluid compositions may be used, and specifically, at least one selected from the group consisting of a tackifier, a flow form modifier, a filtration loss reducer, a high temperature stabilizer, a plugging agent, an inhibition enhancer, and a pH adjuster may be cited. The type and amount of these treating agents may be those known in the art as they are, and are not particularly limited.

According to a preferred embodiment of the present invention, in order to more excellently achieve the technical effect of the present invention, in the mixing step, the substituted scleroglucan and the base slurry are mixed, and then the obtained mixture is mixed optionally with the at least one treating agent.

According to an embodiment of the invention, in the mixing step, the mixing is performed under highspeed stirring, for example, the rotation speed of the high speed stirring is preferably 5000 r/min to 10000 r/min, for preferably 10 min to 30 min.

According to a preferred embodiment of the present invention, the process for producing the drilling fluid composition further comprises a step of subjecting the drilling fluid composition obtained in the mixing step to an aging treatment (called as an aging step).

According to an embodiment of the present invention, in the aging step, the treatment is generally carried out at a temperature of 120-200° C. or 140-180° C., preferably 155-165° C., for generally 10-30 hours or 15-20 hours, preferably 15-17 hours.

### EXAMPLES

The present invention will be described in further detail below referring to examples and comparative examples, but the present invention is not limited thereto.

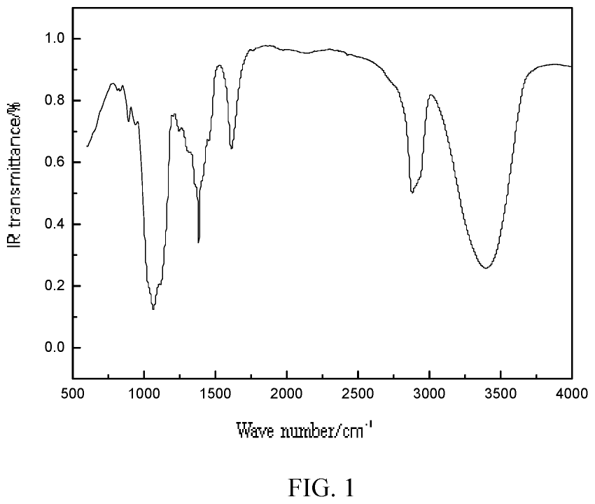

The raw materials used in the following inventive examples and comparative examples were commercially available products. Specifically, the following examples and comparative examples used scleroglucan (n=7400-7600) as shown in FIG. 1, in the infrared spectrum of which, regarding the scleroglucan molecule, 3405 cm⁻¹ represented the stretching vibration peak of O—H bond and 2878 cm⁻¹ represented the stretching vibration absorption peak of C—H bond of methyl group and methylene group, for determining the structure containing scleroglucan; the 1387 cm⁻¹ represented a —C—H— symmetrical bending vibration absorption peak, the 1064 cm⁻¹ represented a C—O stretching vibration absorption peak. The infrared spectrum well reflected the main characteristic absorption peak of the scleroglucan.

### Example 1

12 g of scleroglucan, 180 g of water and 4 g of sodium hydroxide were added into a polymerization reactor, controlling the stirring speed at 1000 r/min. Alkalizing gelatinization was carried out at 60° C. for 0.5 h to obtain scleroglucan gel. 20 g of acrylic acid, 15 g of vinyl pyrrolidone, 54 g of acrylamide, 27 g of 2-acrylamido-2-methylpropanesulfonic acid, 6 g of sodium hydroxide and 50 g of water were added into a mixing reactor, and were homogeneously stirred under a stirring speed of 1000 r/min at a temperature of 30° C., to obtain a monomer aqueous solution. The scleroglucan gel above was mixed with the monomer aqueous solution, and homogeneously stirred under a stirring speed of 1000 r/min. A 40% sodium hydroxide aqueous solution was used to adjust the pH value of the reaction solution to 8. 0.12 g of a hydrogen peroxide initiator was added into the reaction solution, and reacted at 40° C. for 4 hours, to obtain a creamy yellow semitransparent viscous liquid, which was dried in an oven at 80° C. and crushed, to obtain a high-temperature-resistant tackifying agent of the substituted scleroglucan. The product had a yield of 92.81%.

The product had an amine number of 0.20 mmol/g, and a HLB number of 15.0.

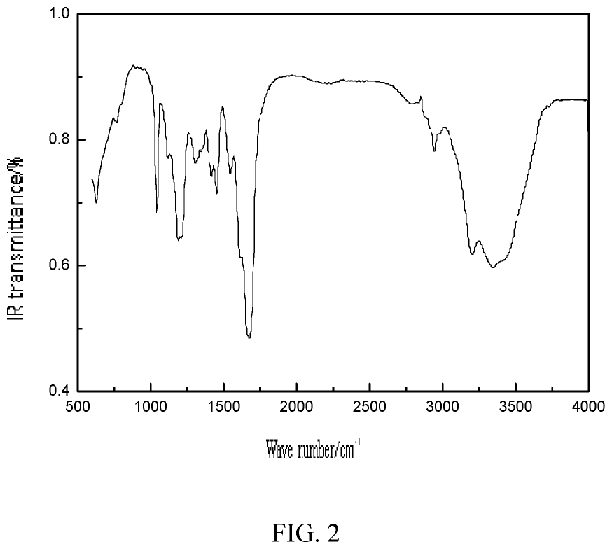

The product produced in this example was subjected to an infrared detection, and the result (shown in FIG. 2) comprised: a characteristic peak at 2938 cm⁻¹, showing the presence of the substituent A or the substituent A′; a characteristic peak at 1195 cm⁻¹, showing the presence of the substituent B′; characteristic peaks at 1049 and 1195 cm⁻¹, showing the presence of the substituent B″; a characteristic peak at 1674 cm⁻¹, showing the presence of the substituent C or the substituent C′; a characteristic peak at 1453 cm⁻¹, showing the presence of the substituent D or the substituent D′; and a characteristic peak at 2150 cm⁻¹, showing the presence of the substituent E or the substituent E′.

The substituted scleroglucan produced in example 1 of the present invention had a schematic structure shown by formula 1:

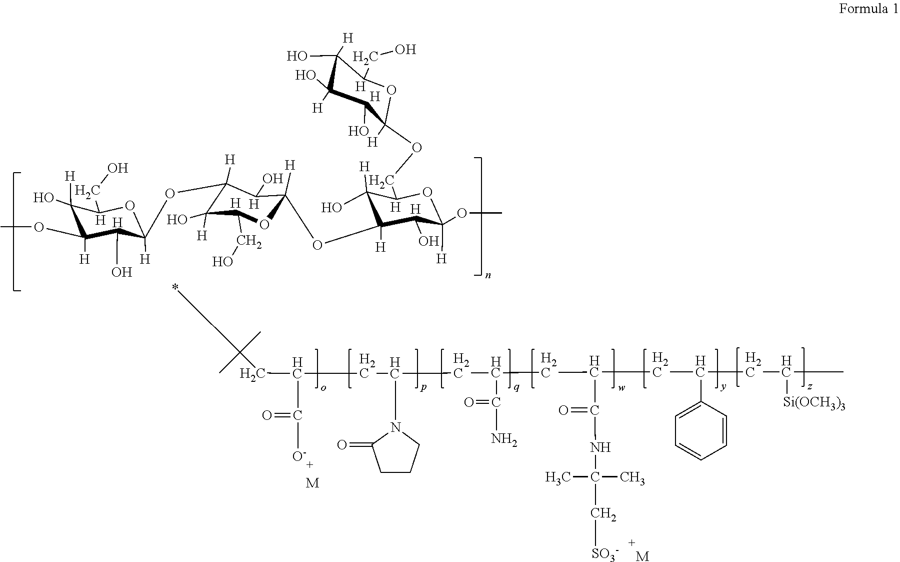

In formula 1: n was 7400-7600, o was 10.5, p was 8.4, q was 12.5, w was 8.2, y was 0, z was 0, and M was Na.

### Example 2

12 g of scleroglucan, 190 g of water and 5 g of sodium hydroxide were added into a polymerization reactor, controlling the stirring speed at 1000 r/mi. Alkalizing gelatinization was carried out at 62° C. for 1.0 h to obtain scleroglucan gel. 20 g of acrylic acid, 16 g of vinyl pyrrolidone, 58 g of acrylamide, 30 g of 2-acrylamide-2-methylpropane sulfonic acid, 7 g of potassium hydroxide, and 60 g of water were added into a mixing reactor, and were homogeneously stirred under a stirring speed of 1100 r/min at a temperature of 35° C., to obtain a monomer aqueous solution.

The scleroglucan gel above was mixed with the monomer aqueous solution, and homogeneously stirred under a stirring speed of 1100 r/min. A 40% o potassium hydroxide aqueous solution was used to adjust the pH value of the reaction solution to 9. 0.16 g of a ammonium persulfate initiator was added into the reaction solution, and reacted at 50° C. for 5 hours, to obtain a creamy yellow semitransparent viscous liquid, which was dried in an oven at 90° C. and crushed, to obtain a high-temperature-resistant tackifying agent of the substituted scleroglucan. The product had a yield of 93.64%.

The product had an amine number of 0.26 mmol/g, and a HLB number of 15.2.

The product produced in this example was subjected to an infrared detection, and the result comprised: a characteristic peak at 2939 cm⁻¹, showing the presence of the substituent A or the substituent A′; a characteristic peak at 1196 cm⁻¹, showing the presence of the substituent B′; characteristic peaks at 1048 and 1196 cm⁻¹, showing the presence of the substituent B″; a characteristic peak at 1675 cm⁻¹, showing the presence of the substituent C or the substituent C′; a characteristic peak at 1454 cm⁻¹, showing the presence of the substituent D or the substituent D′; and a characteristic peak at 2151 cm⁻¹, showing the presence of the substituent E or the substituent E′.

The substituted scleroglucan produced in example 2 of the present invention had a schematic structure shown by formula 2:

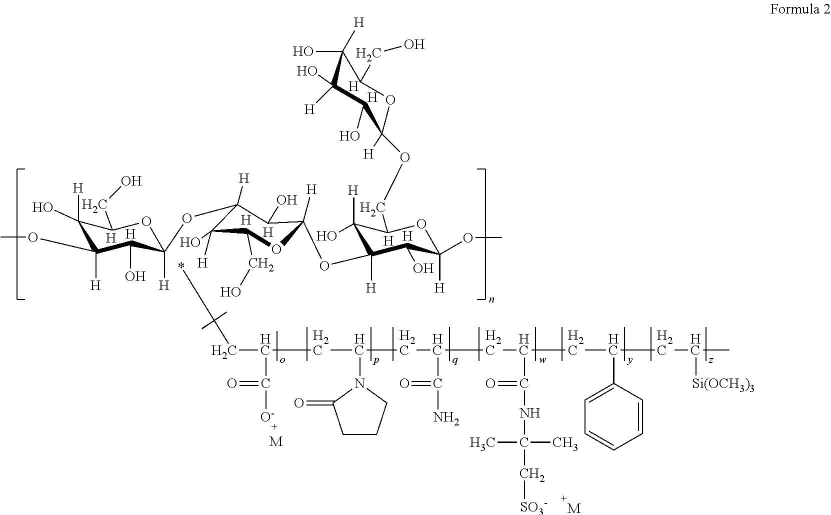

In formula 2: n was 7400-7600, o was 11.2, p was 8.8, q was 12.9, w was 8.7, y was 0, z was 0, and M was K.

### Example 3

12 g of scleroglucan, 200 g of water and 6 g of sodium hydroxide were added into a polymerization reactor, controlling the stirring speed at 1100 r/min. Alkalizing gelatinization was carried out at 64° C. for 1.5 h to obtain a scleroglucan gel. 20 g of acrylic acid, 17 g of vinyl pyrrolidone, 60 g of acrylamide, 32 g of 2-acrylamide-2-methylpropane sulfonic acid, 8 g of potassium hydroxide, and 70 g of water were added into a mixing reactor, and were homogeneously stirred under a stirring speed of 1100 r/min at a temperature of 40° C., to obtain a monomer aqueous solution.

The scleroglucan gel above was mixed with the monomer aqueous solution, and homogeneously stirred under a stirring speed of 1100 r/min. A 40% calcium hydroxide aqueous solution was used to adjust the pH value of the reaction solution to 10. 0.20 g of an azobisisobutyronitrile initiator was added into the reaction solution, and reacted at 60° C. for 7 hours, to obtain a creamy yellow semitransparent viscous liquid, which was dried in an oven at 100° C. and crushed, to obtain a high-temperature-resistant tackifying agent of the substituted scleroglucan. The product had a yield of 93.87%.

The product had an amine number of 0.35 mmol/g, and a HLB number of 16.8.

The product produced in this example was subjected to an infrared detection, and the result comprised: a characteristic peak at 2937 cm⁻¹, showing the presence of the substituent A or the substituent A′; a characteristic peak at 1195 cm⁻¹, showing the presence of the substituent B′; characteristic peaks at 1046 and 1198 cm⁻¹, showing the presence of the substituent B″; a characteristic peak at 1676 cm⁻¹, showing the presence of the substituent C or the substituent C′; a characteristic peak at 1455 cm⁻¹, showing the presence of the substituent D or the substituent D′; and a characteristic peak at 2152 cm⁻¹, showing the presence of the substituent E or the substituent E′.

The substituted scleroglucan produced in example 3 of the present invention had a schematic structure shown by formula 3:

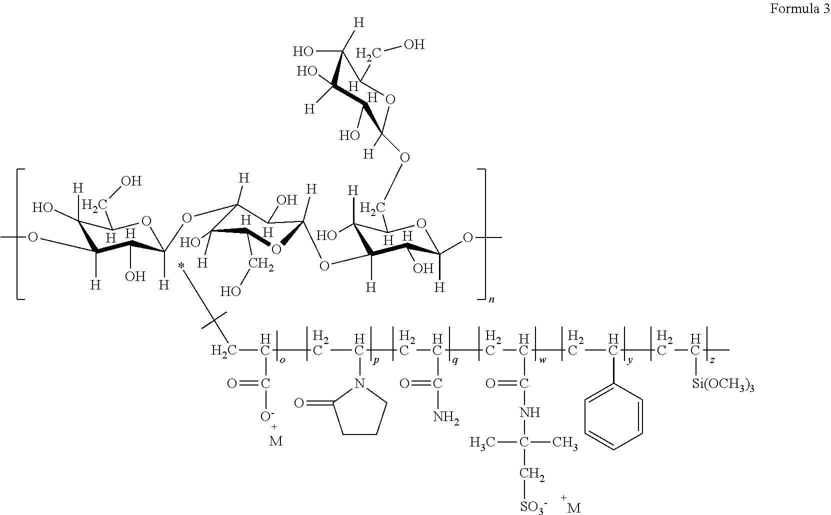

In formula 3: n was 7400-7600, o was 12.5, p was 9.6, q was 13.5, w was 9.2, y was 0, z was 0, and M was Ca.

### Example 4

12 g of scleroglucan, 210 g of water and 7 g of sodium hydroxide were added into a polymerization reactor, controlling the stirring speed at 1100 r/min. Alkalizing gelatinization was carried out at 66° C. for 2.0 h to obtain scleroglucan gel. 20 g of acrylic acid, 18 g of vinyl pyrrolidone, 64 g of acrylamide, 36 g of 2-acrylamido-2-methylpropanesulfonic acid, 8 g of sodium hydroxide and 80 g of water were added into a mixing reactor, and were homogeneously stirred under a stirring speed of 1100 r/min at a temperature of 40° C., to obtain a monomer aqueous solution.

The scleroglucan gel above was mixed with the monomer aqueous solution, and homogeneously stirred under a stirring speed of 1100 r/min. A 40% sodium hydroxide aqueous solution was used to adjust the pH value of the reaction solution to 10. 0.28 g of a ammonium ceric nitrate initiator was added into the reaction solution, and reacted at 70° C. for 9 h, to obtain a creamy yellow semitransparent viscous liquid, which was dried in an oven at 100° C. and crushed, to obtain a high-temperature-resistant tackifying agent of the substituted scleroglucan. The product had a yield of 94.57%.

The product had an amine number of 0.44 mmol/g, and a HLB number of 17.3.

The product produced in this example was subjected to an infrared detection, and the result comprised: a characteristic peak at 2936 cm⁻¹, showing the presence of the substituent A or the substituent A′; a characteristic peak at 1196 cm⁻¹, showing the presence of the substituent B′; characteristic peaks at 1048 and 1197 cm⁻¹, showing the presence of the substituent B″; a characteristic peak at 1677 cm⁻¹, showing the presence of the substituent C or the substituent C′; a characteristic peak at 1456 cm⁻¹, showing the presence of the substituent D or the substituent D′; and a characteristic peak at 2154 cm⁻¹, showing the presence of the substituent E or the substituent E′.

The substituted scleroglucan produced in example 4 of the present invention had a schematic structure shown by formula 4:

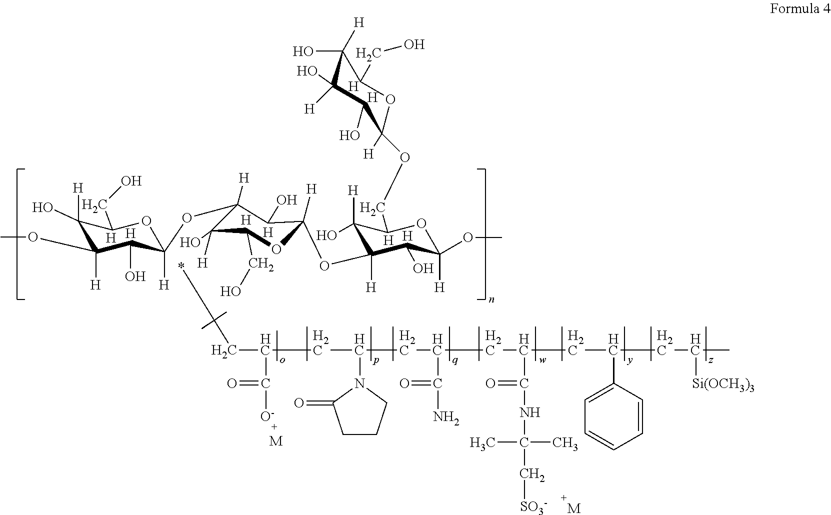

In formula 4: n was 7400-7600, o was 13.1, p was 9.7, q was 13.8, w was 9.4, y was 0, z was 0, and M was Na.

### Example 5

12 g of scleroglucan, 220 g of water and 8 g of sodium hydroxide were added into a polymerization reactor, controlling the stirring speed at 1100 r/min. Alkalizing gelatinization was carried out at 70° C. for 2.0 h to obtain scleroglucan gel. 20 g of acrylic acid, 18 g of vinyl pyrrolidone, 64 g of acrylamide, 36 g of 2-acrylamido-2-methylpropanesulfonic acid, 8 g of sodium hydroxide and 80 g of water were added into a mixing reactor, and were homogeneously stirred under a stirring speed of 1100 r/min at a temperature of 40° C., to obtain a monomer aqueous solution.

The scleroglucan gel above was mixed with the monomer aqueous solution, and homogeneously stirred under a stirring speed of 1100 r/min. A 40% sodium hydroxide aqueous solution was used to adjust the pH value of the reaction solution to 10. The product had a yield of 96.20%.

The product had an amine number of 0.49 mmol/g, and a HLB number of 18.0.

The product produced in this example was subjected to an infrared detection, and the result comprised: a characteristic peak at 2939 cm⁻¹, showing the presence of the substituent A or the substituent A′; a characteristic peak at 1198 cm⁻¹, showing the presence of the substituent B′; characteristic peaks at 1049 and 1197 cm⁻¹, showing the presence of the substituent B″; a characteristic peak at 1678 cm⁻¹, showing the presence of the substituent C or the substituent C′; a characteristic peak at 1457 cm⁻¹, showing the presence of the substituent D or the substituent D′; and a characteristic peak at 2156 cm⁻¹, showing the presence of the substituent E or the substituent E′.

The substituted scleroglucan produced in example 5 of the present invention had a schematic structure shown by formula 5:

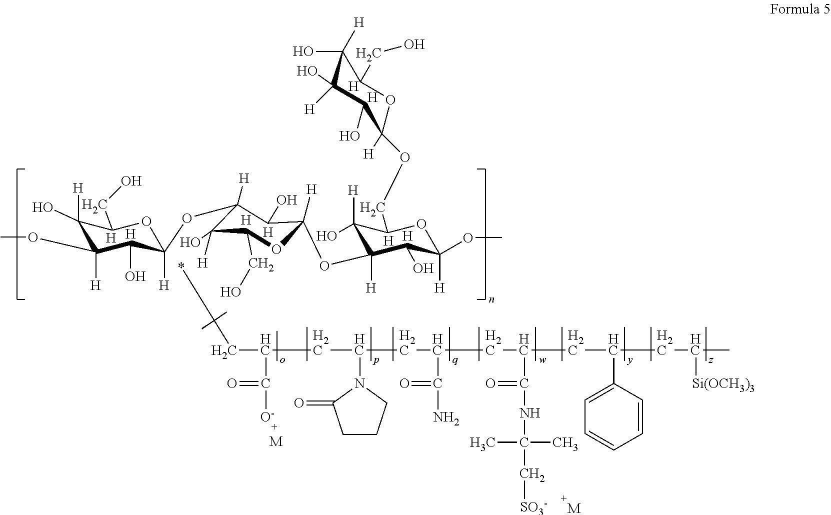

In formula 5: n was 7400-7600, o was 13.7, p was 9.9, q was 13.9, w was 9.7, y was 0, z was 0, and M was Na.

### Example 6

12 g of scleroglucan, 220 g of water and 8 g of sodium hydroxide were added into a polymerization reactor, controlling the stirring speed at 1100 r/min. Alkalizing gelatinization was carried out at 70° C. for 2.0 h to obtain scleroglucan gel. 20 g of acrylic acid, 18 g of vinyl pyrrolidone, 64 g of acrylamide, 36 g of 2-acrylamido-2-methylpropanesulfonic acid, 27 g of styrene, 9 g of vinyl trimethoxy siloxane, 8 g of sodium hydroxide and 80 g of water were added into a mixing reactor, and were homogeneously stirred under a stirring speed of 1100 r/min at a temperature of 40° C., to obtain a monomer aqueous solution. The scleroglucan gel above was mixed with the monomer aqueous solution, and homogeneously stirred under a stirring speed of 1100 r/min. A 40% sodium hydroxide aqueous solution was used to adjust the pH value of the reaction solution to 10. 0.12 g of sodium bisulfite, and 0.24 g of ammonium persulfate initiator were added into the reaction solution, and reacted at 70° C. for 10 h, to obtain a creamy yellow semitransparent viscous liquid, which was dried in an oven at 100° C. and crushed, to obtain a high-temperature-resistant tackifying agent of the substituted scleroglucan. The product had a yield of 96.54%.

The product had an amine number of 0.52 mmol/g, and a HLB number of 18.6.

The product produced in this example was subjected to an infrared detection, and the result comprised: a characteristic peak at 2938 cm⁻¹, showing the presence of the substituent A or the substituent A′; a characteristic peak at 1199 cm⁻¹, showing the presence of the substituent B′; characteristic peaks at 1046 and 1195 cm⁻¹, showing the presence of the substituent B″; a characteristic peak at 1677 cm⁻¹, showing the presence of the substituent C or the substituent C′; a characteristic peak at 1459 cm⁻¹, showing the presence of the substituent D or the substituent D′; and a characteristic peak at 2157 cm⁻¹, showing the presence of the substituent E or the substituent E′.

The substituted scleroglucan produced in example 6 of the present invention had a schematic structure shown by formula 6:

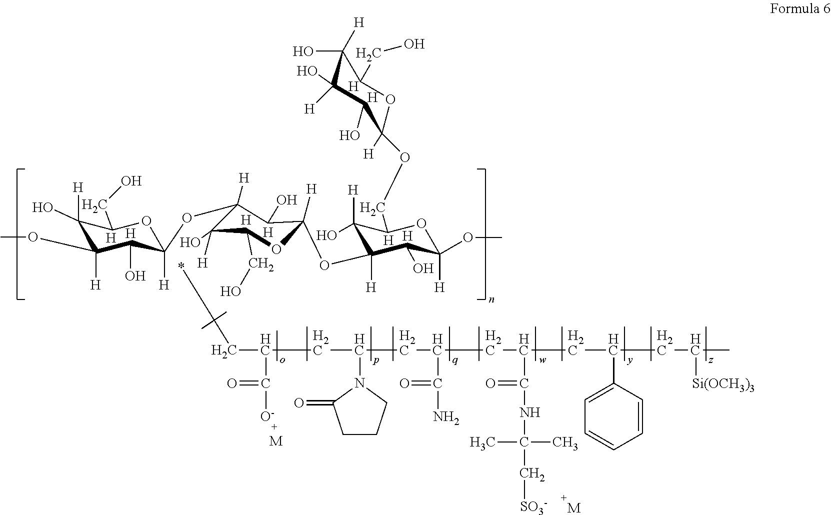

In formula 6: n was 7400-7600, o was 13.9, p was 10.6, q was 14.4, w was 9.8, y was 10.9, z was 3.3, and M was Na.

### Example 7

12 g of scleroglucan, 220 g of water and 8 g of sodium hydroxide were added into a polymerization reactor, controlling the stirring speed at 1100 r/min. Alkalizing gelatinization was carried out at 70° C. for 2.0 h to obtain scleroglucan gel. 20 g of acrylic acid, 18 g of vinyl pyrrolidone, 64 g of acrylamide, 36 g of 2-acrylamido-2-methylpropanesulfonic acid, 45 g of styrene, 15 g of vinyl triethoxy siloxane, 8 g of sodium hydroxide and 80 g of water were added into a mixing reactor, and were homogeneously stirred under a stirring speed of 1100 r/min at a temperature of 40° C., to obtain a monomer aqueous solution. The scleroglucan gel above was mixed with the monomer aqueous solution, and homogeneously stirred under a stirring speed of 1100 r/min. A 40% sodium hydroxide aqueous solution was used to adjust the pH value of the reaction solution to 10. 0.12 g of sodium bisulfite, and 0.24 g of ammonium persulfate initiator were added into the reaction solution, and reacted at 70° C. for 10 h, to obtain a creamy yellow semitransparent viscous liquid, which was dried in an oven at 100° C. and crushed, to obtain a high-temperature-resistant tackifying agent of the substituted scleroglucan. The product had a yield of 96.69%.

The product had an amine number of 0.60 mmol/g, and a HLB number of 20.0.

The product produced in this example was subjected to an infrared detection, and the result comprised: a characteristic peak at 2936 cm⁻¹, showing the presence of the substituent A or the substituent A′; a characteristic peak at 1197 cm⁻¹, showing the presence of the substituent B′; characteristic peaks at 1047 and 1196 cm⁻¹, showing the presence of the substituent B″; a characteristic peak at 1678 cm⁻¹, showing the presence of the substituent C or the substituent C′; a characteristic peak at 1458 cm⁻¹, showing the presence of the substituent D or the substituent D′; and a characteristic peak at 2159 cm⁻¹, showing the presence of the substituent E or the substituent E′.

The substituted scleroglucan produced in example 7 of the present invention had a schematic structure shown by formula 7:

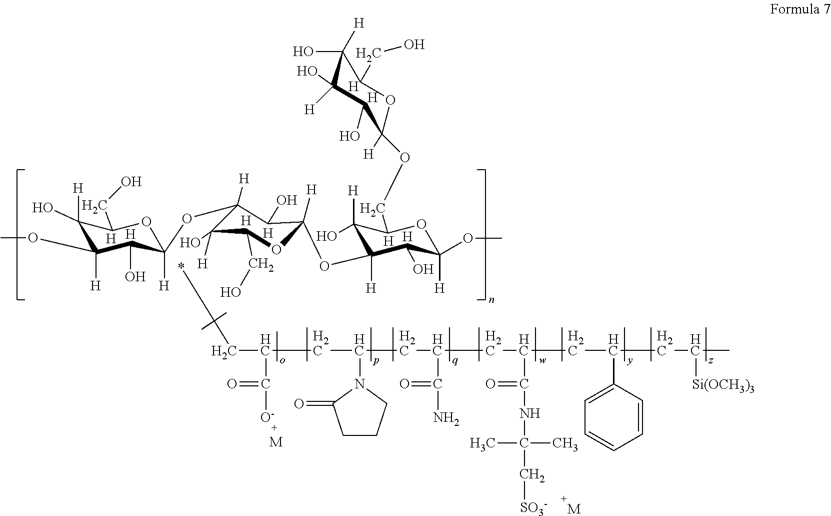

In formula 7: n was 7400-7600, o was 15.0, p was 14.2, q was 14.9, w was 9.9, y was 14.9, z was 4.9, and M was Na.

### Comparative Example 1

12 g of chitosan, 180 g of water and 4 g of sodium hydroxide were added into a polymerization reactor, controlling the stirring speed at 1000 r/min. Alkalizing gelatinization was carried out at 60° C. for 0.5 h to obtain chitosan aqueous solution. 20 g of acrylic acid, 15 g of vinyl pyrrolidone, 54 g of acrylamide, 27 g of 2-acrylamido-2-methylpropanesulfonic acid, 6 g of sodium hydroxide and 50 g of water were added into a mixing reactor, and were homogeneously stirred under a stirring speed of 1000 r/min at a temperature of 30° C., to obtain a monomer aqueous solution. The chitosan aqueous solution above was mixed with the monomer aqueous solution, and homogeneously stirred under a stirring speed of 1000 r/min. A 40% sodium hydroxide aqueous solution was used to adjust the pH value of the reaction solution to 8. 0.12 g of sodium bisulfite, and 0.24 g of ammonium persulfate initiator were added into the reaction solution, and reacted at 40° C. for 4 h, to obtain a creamy yellow semitransparent viscous liquid, which was dried in an oven at 80° C. and crushed, to obtain a high-temperature-resistant tackifying agent of the substituted chitosan.

The product had a yield of 86.14%.

### Comparative Example 2

12 g of cyclodextrin, 180 g of water and 4 g of sodium hydroxide were added into a polymerization reactor, controlling the stirring speed at 1000 r/min. Alkalizing gelatinization was carried out at 60° C. for 0.5 h to obtain cyclodextrin aqueous solution. 20 g of acrylic acid, 15 g of vinyl pyrrolidone, 54 g of acrylamide, 27 g of 2-acrylamido-2-methylpropanesulfonic acid, 6 g of sodium hydroxide and 50 g of water were added into a mixing reactor, and were homogeneously stirred under a stirring speed of 1000 r/min at a temperature of 30° C., to obtain a monomer aqueous solution. The cyclodextrin aqueous solution above was mixed with the monomer aqueous solution, and homogeneously stirred under a stirring speed of 1000 r/min. A 40% sodium hydroxide aqueous solution was used to adjust the pH value of the reaction solution to 8. 0.12 g of sodium bisulfite, and 0.24 g of ammonium persulfate initiator were added into the reaction solution, and reacted at 40° C. for 4 h, to obtain a creamy yellow semitransparent viscous liquid, which was dried in an oven at 80° C. and crushed, to obtain a high-temperature-resistant tackifying agent of the substituted cyclodextrin. The product had a yield of 85.73%.

### Comparative Example 3

12 g of scleroglucan, 180 g of water and 4 g of sodium hydroxide were added into a polymerization reactor, controlling the stirring speed at 1000 r/min. Alkalizing gelatinization was carried out at 60° C. for 0.5 h, to obtain a scleroglucan gel. 20 g of acrylic acid, 6 g of sodium hydroxide and 50 g of water were added into a mixing reactor, and were homogeneously stirred under a stirring speed of 1000 r/min at a temperature of 30° C., to obtain a monomer aqueous solution.

The scleroglucan gel above was mixed with the monomer aqueous solution, and homogeneously stirred under a stirring speed of 1000 r/min. A 40% sodium hydroxide aqueous solution was used to adjust the pH value of the reaction solution to 8. 0.12 g of sodium bisulfite, and 0.24 g of ammonium persulfate initiator were added into the reaction solution, and reacted at 40° C. for 4 h, to obtain a creamy yellow semitransparent viscous liquid, which was dried in an oven at 80° C. and crushed, to obtain a high-temperature-resistant tackifying agent of the substituted scleroglucan. The product had a yield of 90.90%.

### Comparative Example 4

12 g of scleroglucan, 180 g of water and 4 g of sodium hydroxide were added into a polymerization reactor, controlling the stirring speed at 1000 r/min. Alkalizing gelatinization was carried out at 60° C. for 0.5 h, to obtain a scleroglucan gel. 54 g of acrylamide, 6 g of sodium hydroxide and 50 g of water were added into a mixing reactor, and were homogeneously stirred under a stirring speed of 1000 r/min at a temperature of 30° C., to obtain a monomer aqueous solution.

The scleroglucan gel above was mixed with the monomer aqueous solution, and homogeneously stirred under a stirring speed of 1000 r/min. A 40% sodium hydroxide aqueous solution was used to adjust the pH value of the reaction solution to 8. 0.12 g of sodium bisulfite, and 0.24 g of ammonium persulfate initiator were added into the reaction solution, and reacted at 40° C. for 4 h, to obtain a creamy yellow semitransparent viscous liquid, which was dried in an oven at 80° C. and crushed, to obtain a high-temperature-resistant tackifying agent of the substituted scleroglucan. The product had a yield of 91.57%.

### Comparative Example 5

12 g of scleroglucan, 180 g of water and 4 g of sodium hydroxide were added into a polymerization reactor, controlling the stirring speed at 1000 r/min. Alkalizing gelatinization was carried out at 60° C. for 0.5 h, to obtain a scleroglucan gel. 15 g of vinyl pyrrolidone, 6 g of sodium hydroxide and 50 g of water were added into a mixing reactor, and were homogeneously stirred under a stirring speed of 1000 r/min at a temperature of 30° C., to obtain a monomer aqueous solution. The scleroglucan gel above was mixed with the monomer aqueous solution, and homogeneously stirred under a stirring speed of 1000 r/min. A 40% sodium hydroxide aqueous solution was used to adjust the pH value of the reaction solution to 8. 0.12 g of sodium bisulfite, and 0.24 g of ammonium persulfate initiator were added into the reaction solution, and reacted at 40° C. for 4 h, to obtain a creamy yellow semitransparent viscous liquid, which was dried in an oven at 80° C. and crushed, to obtain a high-temperature-resistant tackifying agent of the substituted scleroglucan. The product had a yield of 91.65%.

### Application Examples

The substituted scleroglucans with a weight concentration of 0.3% produced in the Examples 1-7 of the invention were hot rolled in 4% soil slurry at 150° C. for 16 h, and the tackifying performance, the filtration loss reducing performance and the biotoxicity EC₅₀ value were tested, and the test results were shown in Table 1.

According to GB/T16783.1-2014, “Petroleum and natural gas industries-Field testing of drilling fluids-Part 1: Water-basedfluids” the apparent viscosity, plastic viscosity, dynamic shear force, static shear force, and medium-pressure filtration loss.

The drilling fluid compositions were tested for biotoxicity according to the following process:
adding the drilling fluid composition into a solution of sodium chloride at a weight concentration of 3%, formulating respectively into 10 mL of sample solutions to be tested at 0 mg·dm³, 5000 mg·dm³, 10000 mg·dm³, 25000 mg·dm³, 50000 mg·dm³ and 100000 mg·dm³, and standing for 60 min; and
adding sequentially 10 mg of luminous bacteria T3 powder into the sample solutions to be detected, fully shaking and uniformly mixing, and determining respectively the biotoxicity EC₅₀ values 15 min after the luminous bacteria being contacted with the sample solution to be detected, with taking a sodium chloride solution at a weight concentration of 3% as a control.

TABLE 1
results of tackifying, filtration loss reducing and biotoxicity
tests of the substituted scleroglucan samples

| | | | | | | EC₅₀ |
|---|---|---|---|---|---|---|
| | AV/ | PV/ | YP/ | G′/G″/ | FL_{API}/ | values/ |
| Formulation(s) | mPa · s | mPa · s | Pa | (Pa/Pa) | mL | mg/L |
| 4.0% soil slurry | 3.0 | 2.0 | 1.0 | 0.5/0.5 | 40.0 | — |
| 4.0% soil slurry + | 6.5 | 5.0 | 1.5 | 0.5/1.0 | 22.0 | — |
| 0.3% xanthan | | | | | | |
| gum | | | | | | |
| 4.0% soil slurry + | 20.0 | 15.0 | 5.0 | 1.5/5.0 | 9.0 | 553400 |
| 0.3% Ex. 1 | | | | | | |
| 4.0% soil slurry + | 21.0 | 15.0 | 6.0 | 1.5/5.0 | 8.8 | 551900 |
| 0.3% Ex. 2 | | | | | | |
| 4.0% soil slurry + | 20.5 | 15.0 | 5.5 | 1.5/4.5 | 8.8 | 565700 |
| 0.3% Ex. 3 | | | | | | |
| 4.0% soil slurry + | 20.0 | 15.0 | 5.0 | 1.5/5.0 | 9.2 | 538200 |
| 0.3% Ex. 4 | | | | | | |
| 4.0% soil slurry + | 22.5 | 15.0 | 7.5 | 2.0/6.0 | 8.2 | 549800 |
| 0.3% Ex. 5 | | | | | | |
| 4.0% soil slurry + | 26.0 | 18.0 | 8.0 | 3.0/8.5 | 8.0 | 557900 |
| 0.3% Ex. 6 | | | | | | |
| 4.0% soil slurry + | 28.5 | 19.0 | 9.5 | 3.5/9.5 | 7.8 | 562100 |
| 0.3% Ex. 7 | | | | | | |
| 4.0% soil slurry + | 8.5 | 6.0 | 2.5 | 0.5/1.0 | 19.6 | 531500 |
| 0.3% C.E. 1 | | | | | | |
| 4.0% soil slurry + | 10.0 | 8.0 | 2.0 | 0.5/1.0 | 15.8 | 533900 |
| 0.3% C.E. 2 | | | | | | |
| 4.0% soil slurry + | 12.0 | 9.0 | 3.0 | 1.0/1.5 | 13.4 | 539500 |
| 0.3% C.E. 3 | | | | | | |
| 4.0% soil slurry + | 13.0 | 10.0 | 3.0 | 1.0/1.5 | 12.8 | 532700 |
| 0.3% C.E. 4 | | | | | | |
| 4.0% soil slurry + | 13.5 | 10.0 | 3.5 | 1.0/2.0 | 12.4 | 536600 |
| 0.3% C.E. 5 | | | | | | |

As could be seen from the data in Table 1, after aging for 16 h at 150° C., the 0.3% substituted scleroglucan sample could lead a 4% soil slurry to: an increase in apparent viscosity from 3.0 mPa·s to ≥20 mPa·s, i.e., an increase rate of the apparent viscosity of ≥566.67%; an increase in initial static shear force from 0.5 Pa to ≥1.5 Pa, i.e., an increase rate of initial static sheer force of ≥200%; an increase in final static shear force from 0.5 Pa to ≥4.5 Pa, i.e., an increase of the final static sheer force of ≥800%; and better tackifying performance. In addition, the API filtration loss was reduced from 40 mL to ≤9.2 mL, representing a filtration loss reduction rate of ≥77%, showing a better filtration loss reduction performance. Moreover, the substituted scleroglucan samples had a EC₅₀ value of >530000 mg/L (which was much higher than the emission standard of 30000 mg/L), and the substituted scleroglucan samples had no biological toxicity and were green and environment-friendly. Compared with the comparative samples, the tackifying performance and the filtration loss reducing performance of the substituted scleroglucan sample were greatly improved.

As previously mentioned, the substituted scleroglucan of the invention shows excellent tackifying performance under high temperature conditions, has excellent filtration loss reducing performance, is green and environment-friendly. The substituted scleroglucan of the invention is particularly suitable for drilling fluid for deep well and ultra-deep well drilling construction with higher formation temperature, and can achieve green, safe and efficient drilling of high-temperature strata.

1. A substituted scleroglucan or a mixture of a plurality of substituted scleroglucans, each or in combination having substituent A, substituent B and substituent C, and optionally each or in combination having substituent D and substituent E, wherein the substituent A comprises in its structure a unit-C(═O)—O— (preferably comprising a unit-C(═O)—O—R₁, wherein R₁ is selected from the group consisting of a hydrogen atom, an alkali metal (such as K or Na), an alkaline earth metal (such as Ca or Mg), ammonium (NH₄) and C1-10 or C1-4 linear or branched alkyl group), and the substituent B comprises in its structure a unit —C(═O)—NH— (preferably comprising a unit —C(═O)—NH—R₂, wherein R₂ is selected from the group consisting of a hydrogen atom and an optionally substituted C1-10 or C1-4 linear or branched alkyl group), the substituent C comprises in its structure a unit 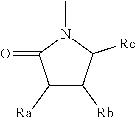
(wherein Ra, Rb and Rc, which are the same or different from each other, are each independently selected from a hydrogen atom and a C1-10 or C1-4 linear or branched alkyl group, preferably a hydrogen atom), the substituent D comprises in its structure an aryl group (preferably a phenyl group), and the substituent E comprises in its structure a siloxane group (preferably a siloxane group represented by —Si(OR′)₃, wherein R′ is a C1-4 linear or branched alkyl group, preferably a methyl or ethyl group).

2. The substituted scleroglucan or a mixture of a plurality of substituted scleroglucans according to claim 1, wherein the substituent A is represented by formula (A-1), formula (A-2), or formula (A-3), 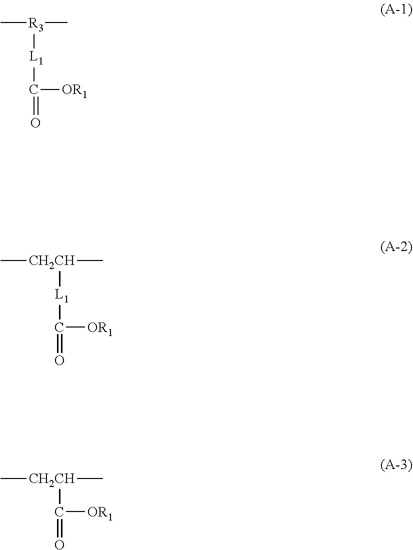
In the preceding formulae, the group R₃ is selected from C2-6 or C2-3 linear or branched alkylene (preferably ethylene or propylene), the group L₁ is selected from any linking group (preferably a single bond or C1-10 or C1-4 linear or branched alkylene, especially a single bond) preferably having no more than 10 carbon atoms, R₁ is selected from hydrogen, alkali metal (such as K or Na), alkaline earth metal (such as Ca or Mg), ammonium (NH₄) and C1-10 or C1-4 linear or branched alkyl),
The substituent B is represented by the following formula (B-1), formula (B-11), formula (B-12), formula (B-2), formula (B-21), formula (B-22), formula (B-3), formula (B-31) or formula (B-32), 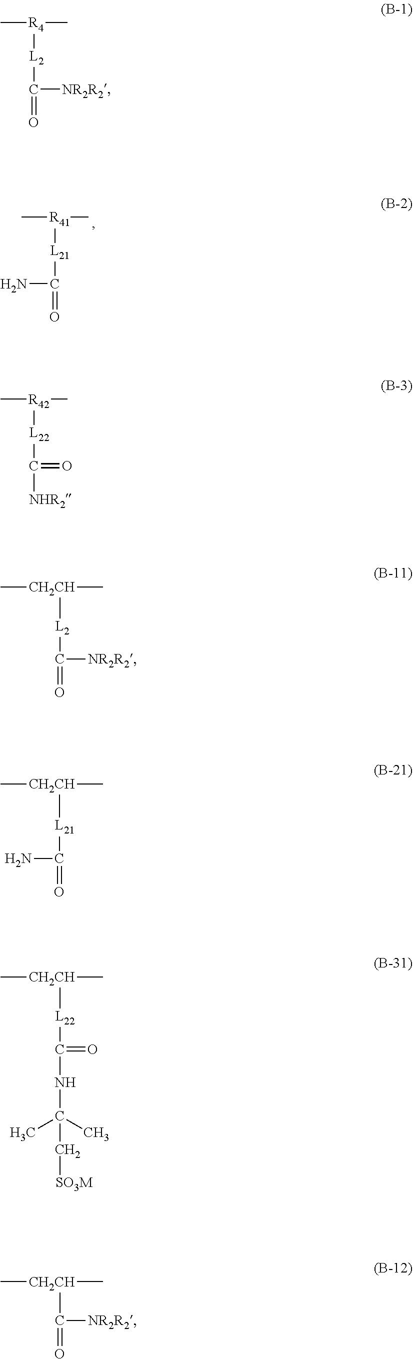 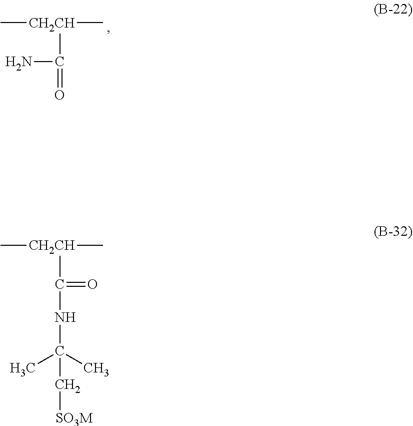
In the preceding formulae, the groups R₄, R₄₁, R₄₂, same as or different from each other, are each independently selected from C2-6 or C2-3 linear or branched alkylene (preferably ethylene or propylene); the groups L₂, L₂₁, and L₂₂, same as or different from each other, are each independently selected from any linking group (preferably single bond or C1-10 or C1-4 linear or branched alkylene, especially single bond), preferably having no more than 10 carbon atoms; M is an alkali metal (such as K or Na), an alkaline earth metal (such as Ca or Mg) or ammonium (NH₄); R₂ is selected from a hydrogen atom and an optionally substituted C1-10 or C1-4 linear or branched alkyl, R₂′ is a hydrogen atom, R₂″ is selected from an optionally substituted C1-10 or C1-4 linear or branched alkyl,
The substituent C is represented by the following formula (C-1), formula (C-2) or formula (C-3), 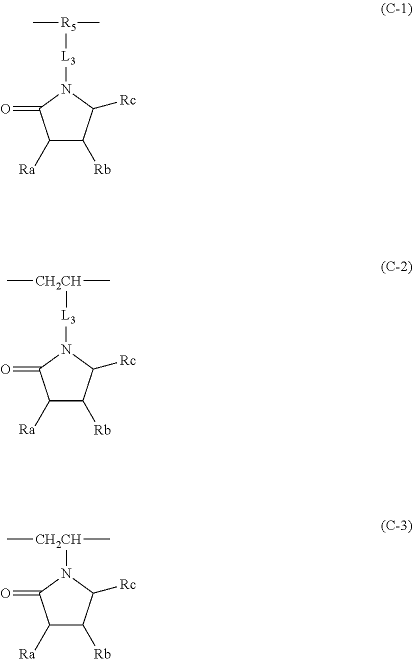
In the preceding formulae, the group R₅ is selected from C2-6 or C2-3 linear or branched alkylene (preferably ethylene or propylene); the group L₃ is selected from any linking group (preferably a single bond or C1-10 or C1-4 linear or branched alkylene, especially a single bond) preferably having no more than 10 carbon atoms; Ra, Rb and Rc, same as or different from each other, are each independently selected from a hydrogen atom and C1-10 or C1-4 linear or branched alkyl (preferably a hydrogen atom),
The substituent D is represented by the following formula (D-1) or formula (D-2), 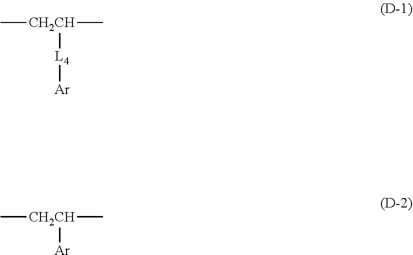
In the preceding formula, the group L₄ is selected from any linking group (preferably a single bond or a C1-10 or C1-4 linear or branched alkylene group, especially a single bond) preferably having no more than 10 carbon atoms, Ar is selected from a C6-20 aryl group (preferably phenyl),
The substituent E is represented by the following formula (E-1) or formula (E-2), 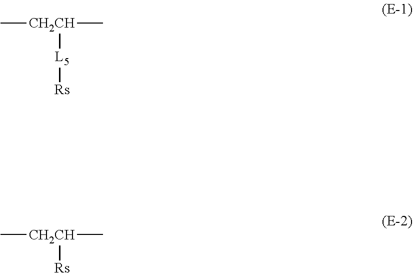
In the preceding formula, the group L₅ is selected from any linking group (preferably a single bond or a C1-10 or C1-4 linear or branched alkylene group, especially a single bond), preferably having no more than 10 carbon atoms; Rs is a siloxane group represented by —Si(OR′)₃ (wherein R′ is a C1-4 linear or branched alkyl group, preferably methyl or ethyl).

3. The substituted scleroglucan or a mixture of substituted scleroglucans according to claim 1, which is a substituted scleroglucan represented by formula (I) or a mixture of a plurality thereof, 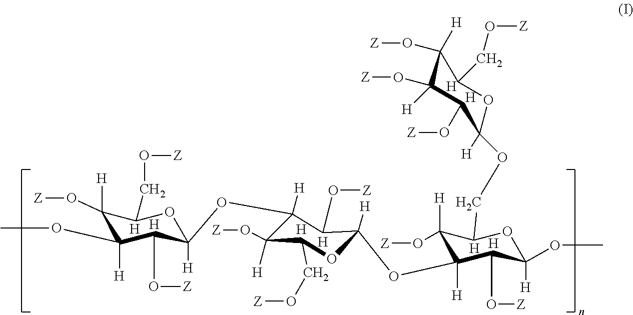
In the formula (I), n is 2000-20000, preferably 5000-10000, most preferably 6000-8000; each occurrence of Z, which are the same as or different from each other, independently represents a hydrogen atom, the substituent A, the substituent B, the substituent C, the substituent D, the substituent E, or a combination group of these substituents, provided that at least one occurrence of Z is not a hydrogen atom; and in each formula (I), assuming the average number of the substituent A is o′, the average number of the substituent B is x′, the average number of the substituent C is p′, the average number of the substituent D is y′, the average number of the substituent E is Z′, then o′ may be any number of from 1-40 (preferably 1-15), p′ may be any number of from 1-20 (preferably 1-10), x′ is any number from 1 to 40 (preferably from 1 to 20), y′ is any number from 0 to 20 (preferably from 1 to 15), and z′ is any number from 0 to 20 (preferably from 1 to 5).

4. The substituted scleroglucan or a mixture of substituted scleroglucans according to claim 1, which is a substituted scleroglucan represented by the following formula (I-1) or a mixture of a plurality thereof, 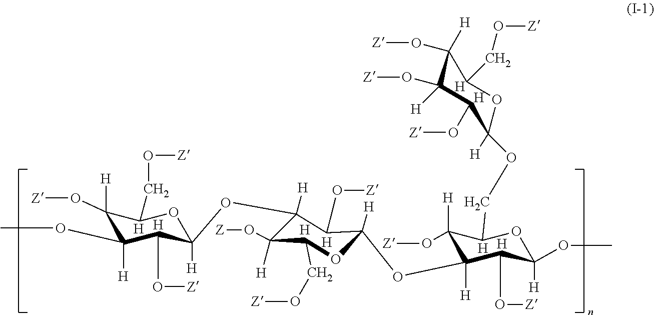
In the formula (I-1), n is 2000-20000, preferably 5000-10000, most preferably 6000-8000, each occurrence of Z′, which is the same as or different from each other, independently represents a hydrogen atom, a substituent A represented by formula (A-3) (called as substituent A′), a substituent B represented by formula (B-22) (called as substituent B′), a substituent B represented by formula (B-32) (called as substituent B″), a substituent C represented by formula (C-3) (called as substituent C′), a substituent D represented by formula (D-2) (called as substituent D′), a substituent E represented by formula (E-2) (called as substituent E′), or a combination group of these substituents, provided that at least one occurrence of Z′ is not a hydrogen atom, and in each formula (I-1), assuming that the average number of the substituents A′ is o, assuming that the average number of the substituents B′ is q, assuming that the average number of the substituents B″ is w, assuming that the average number of the substituents C′ is p, assuming that the average number of the substituents D′ is y, assuming that the average number of the substituents E′ is z, then o may be any number of from 1 to 20 (preferably 1 to 15), p may be any number of from 1 to 20 (preferably 1 to 10), q may be any number of from 1 to 20 (preferably 1 to 15), w may be any number of from 1 to 20 (preferably 1 to 10), y may be any number of from 0 to 20 (preferably 1 to 15), and z may be any number of from 0 to 20 (preferably 1 to 5).

5. The substituted scleroglucan or a mixture of substituted scleroglucans according to claim 4, which is a substituted scleroglucan or mixture of more thereof represented schematically by the following formula (I-2), 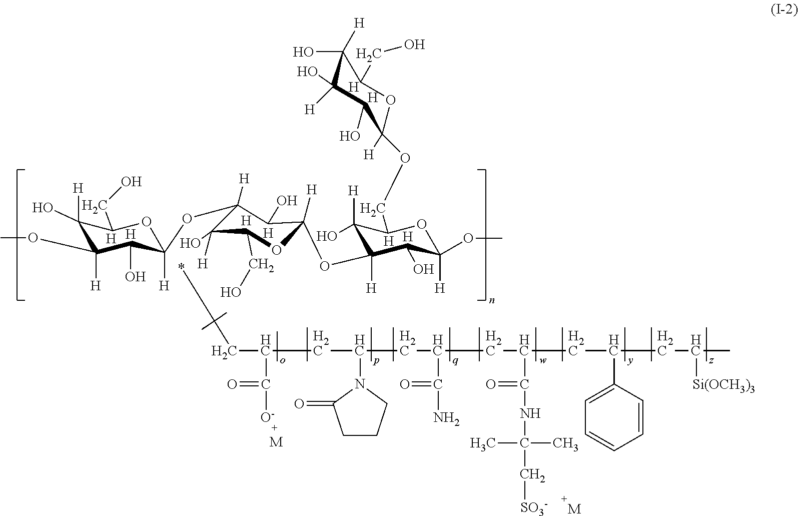
In formula (I-2), M is hydrogen, an alkali metal (such as K or Na), an alkaline earth metal (such as Ca or Mg) or ammonium (NH₄), and * represents a covalent bonding site.

6. A substituted scleroglucan or a mixture of a plurality of substituted scleroglucans according to claim 1, having an amine number of 0.2 to 0.6 mmol/g and/or an HLB value of 15.0 to 20.0.

7. A process of producing a substituted scleroglucan or a mixture of a plurality of substituted scleroglucans, comprising the steps of:
1) gelatinizing a scleroglucan represented by the following formula (A) in the presence of a base (preferably at least one selected from alkali metal hydroxides and alkaline earth metal hydroxides, particularly at least one selected from sodium hydroxide, potassium hydroxide and calcium hydroxide) and water to obtain a scleroglucan gel, 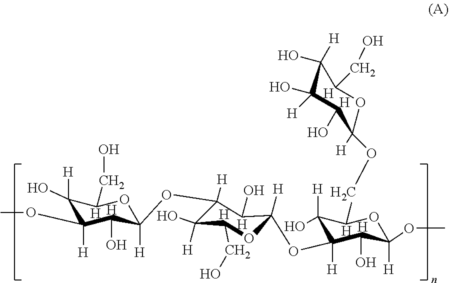
in the formula (A), n is 2000-20000, preferably 5000-10000, and most preferably 6000-8000,
2) mixing (preferably homogeneously mixing) a carboxylic acid monomer represented by formula (X-1), an amide monomer represented by formula (X-2), a sulfonic acid monomer represented by formula (X-3), a pyrrolidone monomer represented by formula (X-4), optionally a phenyl monomer represented by formula (X-5), and optionally a siloxane-based monomer represented by formula (X-6) with water in the presence of a base (preferably at least one selected from the group consisting of alkali metal hydroxides and alkaline earth metal hydroxides, particularly at least one selected from the group consisting of sodium hydroxide, potassium hydroxide and calcium hydroxide) to obtain a mixed monomer, and
3) subjecting the scleroglucan gel and the mixed monomers to a free-radical polymerization reaction in the presence of a free-radical polymerization initiator (preferably at least one selected from peroxide initiators, azo-based initiators, and redox-based initiators, in particular at least one selected from hydrogen peroxide, ammonium persulfate, azobisisobutyronitrile, ceric ammonium nitrate, and 1:2 parts by weight of sodium bisulfite and ammonium persulfate), optionally drying, to obtain the substituted scleroglucan or a mixture of a plurality of substituted scleroglucans, 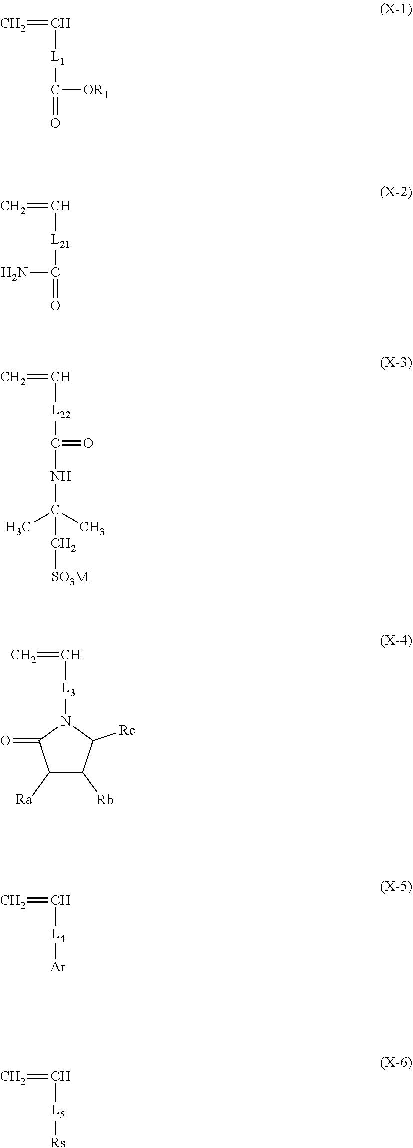
in the formulae (X-1) to (X-6), the groups L₁, L₂₁, L₂₂, L₃, L₄ and L₅, same as or different from each other, are each independently selected from any linking group (preferably a single bond or C1-10 or C1-4 linear or branched alkylene, particularly a single bond) preferably having a carbon number of no more than 10, M is an alkali metal (such as K or Na), an alkaline earth metal (such as Ca or Mg) or ammonium (NH₄), Ra, Rb and Rc, same as or different from each other, are each independently selected from hydrogen and C1-10 or C1-4 linear or branched alkyl (preferably hydrogen), R₁ is selected from hydrogen, an alkali metal (such as K or Na), an alkaline earth metal (such as Ca or Mg), ammonium (NH₄) and C1-10 or C1-4 linear or branched alkyl (preferably hydrogen), Ar is a C6-20 aryl group (preferably phenyl) and Rs is a siloxane group represented by —Si(OR′)₃ (wherein R′ is a C1-4 linear or branched alkyl group, preferably methyl or ethyl).

8. The production process according to claim 7, wherein in the step 1), the weight ratio of the scleroglucan, water and the base is 12:(180-220):(4-8), and/or, in the step 1), the reaction is carried out at a temperature of 60-70° C., for 0.5-2 h, and/or, in the step 2), the weight ratio of the carboxylic acid monomer represented by formula (X-1), the pyrrolidone monomer represented by formula (X-4), the amide monomer represented by formula (X-2), the sulfonic acid monomer represented by formula (X-3), the base and water is 20:(15-18):(54-64):(27-36):(6-8):(50-80), and/or, in the step 2), the weight ratio of the carboxylic acid monomer represented by formula (X-1), the phenyl monomer represented by formula (X-5), and the siloxane-based monomer represented by formula (X-6) is 20:(27-45):(9-15), and/or, in the step 2), the mixing temperature is 30-40° C., and/or, in the step 3), the weight ratio of the mixed monomer (calculated as the total weight of all the monomers), the scleroglucan gel (calculated as the weight of the scleroglucan) and the free radical polymerization initiator is (152-198): 12:(0.8-1.6), and/or, in the step 3), the pH value of the polymerization reaction system is controlled to be 8-10, the reaction temperature is 40-70° C., the reaction duration is 4-10 h, and/or, in the step 3), the drying temperature is 80-100° C.

9. A drilling fluid composition, comprising a substituted scleroglucan, a base slurry and optionally at least one treating agent, wherein the substituted scleroglucan is a substituted scleroglucan or a mixture of a plurality of substituted scleroglucans according to claim 1.

10. A drilling fluid composition according to claim 9, wherein the substituted scleroglucan is present in an amount of 0.5 to 10.0 wt % (preferably 1.5 to 5.0 wt %) by weight, based on 100 wt % of the total weight of the drilling fluid composition.

11. A process of producing a drilling fluid composition, comprising mixing a substituted scleroglucan, a base slurry and optionally at least one treating agent (preferably mixing the substituted scleroglucan with the base slurry first and then mixing the obtained mixture with the optionally at least one treating agent) to obtain the drilling fluid composition, wherein the substituted scleroglucan is a substituted scleroglucan or a mixture of a plurality of substituted scleroglucans according to claim 1, or a substituted scleroglucan, and optionally subjecting the obtained drilling fluid composition to an aging treatment (preferably at a treatment temperature of 120-200° C. or 140-180° C., preferably at a treatment temperature of 155-165° C. for 10-30 hours or 15-20 hours, preferably 15-17 hours).
